(19) United States
(12) Patent Application Publication
(10) Pub. No.: US 2023/0013644 A1
(43) Pub. Date: Jan. 19, 2023

(54) STAGED NUTRITIONAL COMPOSITIONS CONTAINING HUMAN MILK OLIGOSACCHARIDES AND USES THEREOF

(71) Applicant: MJN U.S. HOLDINGS LLC, Evansville, IN (US)

(72) Inventors: Maciej Witalis CHICHLOWSKI, Evansville, IN (US); Gabriele GROSS, Nijmegen (NL); Qian LI, Evansville, IN (US); Sarah Diane MARIA, Evansville, IN (US); Shay Cristine PHILLIPS, Evansville, IN (US); Janna Alida VAN DIEPEN, Nijmegen (NL); Eric Alexander Franciscus VAN TOL, Zeist (NL)

(73) Assignee: MJN U.S. HOLDINGS LLC, Evansville, IN (US)

(21) Appl. No.: 17/781,477

(22) PCT Filed: Dec. 9, 2020
(86) PCT No.: PCT/EP2020/085391

§ 371 Date: Jun. 1, 2022

(30) Foreign Application Priority Data
Dec. 11, 2019 (GB) 1918209.6

(51) Int. Cl. A23C 9/20; A23L 33/00

(52) U.S. Cl. CPC A23C 9/206; A23L 33/30; A23L 33/40

(57) ABSTRACT

The present application provides nutritional compositions comprising human milk oligosaccharides, for use in providing nutrition to infants at different age stages.

### FIELD OF THE INVENTION

The present disclosure relates to nutritional compositions comprising human milk oligosaccharides (HMOs), for use in providing nutrition to infants at different age stages. In this way, HMO composition and concentration can be tailored to more closely meet the nutritional needs of infants, in a practical and effective manner. The disclosed nutritional compositions may provide additive and/or synergistic beneficial health effects.

### BACKGROUND

Human infant gut microbiota is rapidly established in the first few weeks following birth. Gut microbiota development in infants is understood to be initiated by exposure to maternal and environmental bacteria during birth. Further development of gut microbiota is affected by a newborn infant's diet. Whether the infant is breastfed or formula-fed has a strong influence on the intestinal bacterial population and composition. Human milk contains numerous macro- and micronutrient components, the identity and function of which are still being discovered and studied. Among these components, HMOs are believed to play an important role in the growth of beneficial bacteria in infants. In breastfed infants, for example, Bifidobacterium species dominate among intestinal bacteria, while Streptococcus species and Lactobacillus species are less common. In contrast, the microflora of formula-fed infants is more diverse, containing Bifidobacterium species and Bacteroides species as well as more pathogenic organisms such as Staphylococcus, Escherichia coli, and Clostridium species. The species of Bifidobacterium in the stools of breastfed and formula-fed infants vary as well. Bifidobacterium species are generally considered beneficial bacteria and are known to protect against colonisation by pathogenic bacteria.

Gut microbiota is also important for healthy brain function, as it is believed that gut microbiota communicate with the brain via the gut-brain axis, and thus have an impact on brain development and function. More specifically, gut microbiota interact with enteric and central nervous systems via neural, neuroendocrine, neuroimmune, and hormonal links. Brain development and growth exceeds that of any other organ or body tissue, reaching its peak at 26 weeks of gestation and continuing at a rapid rate throughout the first three years of life. Sub-optimal nutrition during this phase may have irreversible consequences for cognitive function.

Human milk is not static in its composition; rather, it varies with lactation stage. There are significant changes in the composition of breast milk which reflect changes in the requirements of the infant based on physiological functions and development. Human milk contains a large diversity of oligosaccharide structures known as HMOs, which function as a prebiotic in the establishment of beneficial microbiota and are protective to infants. HMOs constitute the third largest fraction of human milk, accounting for 1 to 2% of human milk content. Infant-specific Bifidobacteria (e.g. B. longum, B. infantis, B. breve, B. bifidum) have been characterised by their capabilities for consuming HMOs. In addition, HMOs function as decoy receptors for various pathogens. HMOs are able to shape the composition of neonatal gastrointestinal (GI) microbial communities. Different HMOs are differently fermented by gut microbiota, as was shown for breastfed and formula-fed infants.

Accordingly, there exists a need for nutritional compositions that have an HMO composition that changes as the infant ages, instead of simply providing a constant level of HMOs throughout an infant's development, so as to more closely mimic human breast milk at different stages of lactation.

### SUMMARY OF INVENTION

The present disclosure is directed to a plurality of nutritional compositions that comprise HMOs, for providing nutrition to infants at different age stages. The HMOs may comprise 2′-fucosyllactose (2FL), 3′-fucosyllactose (3FL), lacto-N-tetraose (LNT), 6′-sialyllactose (6SL), and 3′-sialyllactose (3SL). Alternatively, the HMOs may comprise 3FL, LNT, 3SL, and 6SL.

In a first aspect, there is provided an age-specific nutritional composition system comprising: at least one stage 1 nutritional composition for infants from 0 to 6 months of age; and, at least one stage 2 nutritional composition for infants from 6 to 12 months of age, wherein the stage 1 and stage 2 nutritional compositions comprise human milk oligosaccharides, wherein the human milk oligosaccharides comprise 2FL, 3FL, LNT, 6SL, and 3SL, and wherein the stage 1 and stage 2 nutritional compositions comprise different amounts of one or more of the human milk oligosaccharides.

Preferably, relative to the stage 2 nutritional composition, the stage 1 nutritional composition comprises a greater amount of 2FL, a smaller amount of 3FL, a greater amount of LNT, a smaller amount of 3SL, a greater amount of 6SL, or any combination thereof.

Preferably, the stage 1 and stage 2 nutritional compositions comprise:

TABLE 1

| | Stage 1 | Stage 2 |
|---|---|---|
| | (g/L) | (g/L) |
| 2FL | 1.5-4 | 1.3-2 |
| 3FL | 0.1-2 | 0.5-2.2 |
| LNT | 1-4.2 | 0.5-1.7 |
| 3SL | 0.01-0.2 | 0.1-0.35 |
| 6SL | 0.01-0.45 | 0.01-0.1 |

In a second aspect, there is provided an age-specific nutritional composition system comprising: at least one stage A nutritional composition for infants from 0 to 3 months of age; at least one stage B nutritional composition for infants from 3 to 6 months of age; and, at least one stage C nutritional composition for infants from 6 to 12 months of age, wherein the stage A, stage B, and stage C nutritional compositions comprise human milk oligosaccharides, wherein the human milk oligosaccharides comprise 2FL, 3FL, LNT, 3SL, and 6SL, and wherein the stage A, stage B, and stage C nutritional compositions each comprise different amounts of one or more of the human milk oligosaccharides.

Preferably, relative to the stage B nutritional composition, the stage A nutritional composition comprises a greater amount of 2FL, a smaller amount of 3FL, a greater amount of LNT, a smaller amount of 3SL, a greater amount of 6SL, or any combination thereof.

Preferably, relative to the stage C nutritional composition, the stage B nutritional composition comprises a greater amount of 2FL, a smaller amount of 3FL, a greater amount of LNT, a smaller amount of 3SL, a greater amount of 6SL, or any combination thereof.

Preferably, the stage A, stage B, and stage C nutritional compositions comprise:

TABLE 2

| | Stage A | Stage B | Stage C |
|---|---|---|---|
| | (g/L) | (g/L) | (g/L) |
| 2FL | 1.5-4 | 1.5-2.2 | 1.3-2 |
| 3FL | 0.1-1.5 | 0.3-2 | 0.5-2.2 |
| LNT | 1-4.2 | 0.7-2 | 0.5-1.7 |
| 3SL | 0.01-0.15 | 0.05-0.2 | 0.1-0.35 |
| 6SL | 0.05-0.45 | 0.01-0.18 | 0.01-0.1 |

In a third aspect, there is provided a nutritional composition system for use in providing nutrition to an infant.

In a fourth aspect, there is provided the use of a nutritional composition system for providing nutrition to an infant.

In a fifth aspect, there is provided an infant nutrition kit comprising a set of nutritional compositions.

In a sixth aspect, there is provided a nutritional composition for infants from 0 to 3 months of age comprising; 1.5 grams per litre (g/L) to 4 g/L of 2FL; 0.1 g/L to 1.5 g/L of 3FL; 1 g/L to 4.2 g/L of LNT; 0.01 g/L to 0.15 g/L of 3SL; and, 0.05 g/L to 0.45 g/L of 6SL.

In a seventh aspect, there is provided a nutritional composition for infants from 0 to 6 months of age comprising: 1.5 g/L to 4 g/L of 2FL; 0.1 g/L to 2 g/L of 3FL; 1 g/L to 4.2 g/L of LNT; 0.01 g/L to 0.2 g/L of 3SL; and, 0.01 g/L to 0.45 g/L of 6SL.

In an eighth aspect, there is provided a nutritional composition for infants from 3 to 6 months of age comprising: 1.5 g/L to 2.2 g/L of 2FL; 0.3 g/L to 2 g/L of 3FL; 0.7 g/L to 2 g/L of LNT; 0.05 g/L to 0.2 g/L of 3SL; and, 0.01 g/L to 0.18 g/L of 6SL.

In a ninth aspect, there is provided a nutritional composition for infants from 6 to 12 months of age comprising: 1.3 g/L to 2 g/L of 2FL; 0.5 g/L to 2.2 g/L of 3FL; 0.5 g/L to 1.7 g/L of LNT; 0.1 g/L to 0.35 g/L of 3SL; and, 0.01 g/L to 0.1 g/L of 6SL.

In a tenth aspect, there is provided a method for the manufacture of a set of nutritional compositions for providing nutrition to an infant comprising: preparing at least one stage A nutritional composition for infants from 0 to 3 months of age, at least one stage B nutritional composition for infants from 3 to 6 months of age, and at least one stage C nutritional composition for infants from 6 to 12 months of age, wherein the stage A, stage B, and stage C nutritional compositions comprise human milk oligosaccharides, wherein the human milk oligosaccharides comprise 2FL, 3FL, LNT, 3SL, and 6SL, wherein preparation of each composition comprises combining a protein source, a carbohydrate source, and a fat or lipid source; and, selecting and incorporating a desired amount of 2FL, 3FL, LNT, 3SL, and 6SL into each of the nutritional compositions, wherein the stage A, stage B, and stage C nutritional compositions each comprise different amounts of one or more of the human milk oligosaccharides.

In an eleventh aspect, there is provided a method for providing nutrition to an infant comprising: feeding an infant of 0 to 3 months of age at least one stage A nutritional composition; feeding an infant of 3 to 6 months of age at least one stage B nutritional composition; and, feeding an infant of 6 to 12 months of age at least one stage C nutritional composition, wherein the stage A, stage B, and stage C nutritional compositions comprise human milk oligosaccharides, wherein the human milk oligosaccharides comprise 2FL, 3FL, LNT, 3SL, and 6SL, and wherein the stage A, stage B, and stage C nutritional compositions each comprise different amounts of one or more of the human milk oligosaccharides.

In a twelfth aspect, there is provided a staged feeding regimen, comprising the steps of: administering a stage 1 nutritional composition to an infant between 0 and 6 months of age; administering a stage 2 nutritional composition to an infant between 6 and 12 months of age, wherein the stage 1 and stage 2 nutritional compositions comprise human milk oligosaccharides, wherein the human milk oligosaccharides comprise 2FL, 3FL, LNT, 3SL, and 6SL, wherein the stage 1 and stage 2 nutritional compositions comprise different amounts of one or more of the human milk oligosaccharides.

Preferably, the stage 1 and stage 2 nutritional compositions comprise:

TABLE 3

| | Stage 1 | Stage 2 |
|---|---|---|
| | (g/L) | (g/L) |
| 2FL | 1.5-4 | 1.3-2 |
| 3FL | 0.1-2 | 0.5-2.2 |
| LNT | 1-4.2 | 0.5-1.7 |
| 3SL | 0.01-0.2 | 0.1-0.35 |
| 6SL | 0.01-0.45 | 0.01-0.1 |

In a thirteenth aspect, there is provided a staged feeding regimen, comprising the steps of: administering a stage A nutritional composition to an infant between 0 and 3 months of age; administering a stage B nutritional composition to an infant between 3 and 6 months of age; administering a stage C nutritional composition to an infant between 6 and 12 months of age, wherein the stage A, stage B, and stage C nutritional compositions comprise human milk oligosaccharides, wherein the human milk oligosaccharides comprise 2FL, 3FL, LNT, 3SL, and 6SL, wherein the stage A, stage B, and stage C nutritional compositions each comprise different amounts of one or more of the human milk oligosaccharides.

Preferably, the stage A, stage B, and stage C nutritional compositions comprise:

TABLE 4

| | Stage A | Stage B | Stage C |
|---|---|---|---|
| | (g/L) | (g/L) | (g/L) |
| 2FL | 1.5-4 | 1.5-2.2 | 1.3-2 |
| 3FL | 0.1-1.5 | 0.3-2 | 0.5-2.2 |
| LNT | 1-4.2 | 0.7-2 | 0.5-1.7 |
| 3SL | 0.01-0.15 | 0.05-0.2 | 0.1-0.35 |
| 6SL | 0.05-0.45 | 0.01-0.18 | 0.01-0.1 |

Preferably, at least one of the nutritional compositions of any one of the first to thirteenth aspects comprises a long-chain polyunsaturated fatty acid. More preferably, the long-chain polyunsaturated fatty acid comprises docosahexaenoic acid, arachidonic acid, or a combination thereof.

Preferably, at least one of the nutritional compositions of any one of the first to thirteenth aspects comprises a probiotic. More preferably, the probiotic comprises Bifidobacterium longum subsp. infantis, Lactobacillus rhamnosus GG (ATCC number 53103), or a combination thereof.

Preferably, at least one of the nutritional compositions of any one of the first to thirteenth aspects comprises a prebiotic. More preferably, the prebiotic comprises polydextrose, galactooligosaccharides, or a combination thereof.

Preferably, at least one of the nutritional compositions of any one of the first to thirteenth aspects comprises lactoferrin.

Preferably, at least one of the nutritional compositions of any one of the first to thirteenth aspects is a synthetic nutritional composition. More preferably, each of the nutritional compositions in any one of the first to thirteenth aspects is a synthetic nutritional composition. Most preferably, all the nutritional compositions, in all of the first to thirteenth aspects are synthetic nutritional compositions.

### DETAILED DESCRIPTION

“Milk” means a substance that has been drawn or extracted from the mammary gland of a mammal.

“Milk-based composition” means a composition comprising any milk-derived or milk-based product known in the art. For example, a “milk-based composition” may comprise bovine casein, bovine whey, bovine lactose, or any combination thereof.

“Enriched milk product” generally refers to a milk ingredient that has been enriched with MFGM and/or certain MFGM components, such as proteins and lipids found in the MFGM.

“Nutritional composition” means a substance or composition that satisfies at least a portion of a subject's nutrient requirements. “Nutritional composition(s)” may refer to liquids, powders, gels, pastes, solids, concentrates, suspensions, or ready-to-use forms of enteral formulas, oral formulas, formulas for infants, formulas for paediatric subjects, formulas for children, young child milks, and/or formulas for adults.

The term “synthetic” when applied to a composition, nutritional composition, or mixture means a composition, nutritional composition, or mixture obtained by biological and/or chemical means, which can be chemically identical to the mixture naturally occurring in mammalian milks. A composition, nutritional composition, or mixture is said to be “synthetic” if at least one of its components is obtained by biological (e.g. enzymatic) and/or chemical means.

“Paediatric subject” means a human under 18 years of age. The term “adult”, in terms of the present disclosure, refers to a human that is 18 years of age or greater. The term “paediatric subject” may refer to preterm infants, full-term infants, and/or children, as described below. A paediatric subject may be a human subject that is between birth and 8 years old. In another aspect, “paediatric subject” refers to a human subject between 1 and 6 years of age. Alternatively, “paediatric subject” refers to a human subject between 6 and 12 years of age.

“Infant” means a human subject ranging in age from birth to not more than one year and includes infants from 0 to 12 months corrected age. The phrase “corrected age” means an infant's chronological age minus the amount of time that the infant was born premature. Therefore, the corrected age is the age of the infant if it had been carried to full term. The term infant includes full-term infants, preterm infants, low birth weight infants, very low birth weight infants, and extremely low birth weight infants. “Preterm” means an infant born before the end of the 37th week of gestation. “Full-term” means an infant born after the end of the 37th week of gestation.

“Child” means a subject ranging from 12 months to 13 years of age. A child may be a subject between the ages of 1 and 12 years old. In another aspect, the terms “children” or “child” may refer to subjects that are between 1 and about 6 years old. Alternatively, the terms “children” or “child” may refer to subjects that are between about 7 and about 12 years old. The term “young child” means a subject ranging from 1 year to 3 years of age.

“Infant formula” means a composition that satisfies at least a portion of the nutrient requirements of an infant.

“Follow-up formula” means a composition that satisfies at least a portion of the nutrient requirements of an infant from the 6th month onwards, and for young children from 1 to 3 years of age.

“Young child milk”, in terms of the present disclosure, means a fortified milk-based beverage intended for children over one year of age (typically from one to six years of age). Young child milks are designed with the intent to serve as a complement to a diverse diet, to provide additional insurance that a child achieves continual, daily intake of all essential vitamins and minerals, macronutrients plus additional functional dietary components, such as non-essential nutrients that have purported health-promoting properties.

The term “enteral” means deliverable through or within the gastrointestinal, or digestive, tract. “Enteral administration” includes oral feeding, intragastric feeding, transpyloric administration, or any other administration into the digestive tract. “Administration” is broader than “enteral administration” and includes parenteral administration or any other route of administration by which a substance is taken into a subject's body.

The term “human milk oligosaccharides” or “HMOs” refers generally to a number of complex carbohydrates found in human breast milk.

The terms “secretor” and “secretor mother” refer to a mother with a functional FUT2 allele, and therefore produce breast milk containing a large amount of α-1,2 fucosylated HMOs, such as 2′-fucosyllactose (2FL), lactodifucotetraose (LDFT), lacto-N-difucohexaose I (LNDFH I), and lacto-N-fucopentaose I (LNFP I). The terms “non-secretor” and “non-secretor mother” refer to a mother with a non-functional FUT2 allele, and therefore produce breast milk containing no, or a minimum level of, α-1,2 fucosylated HMOs, such as 2FL, LDFT, LNDFH I, and LNFP I. The level of 2FL in breast milk has been shown to be a particularly reliable indicator of the secretor status of a mother, so by determining the level of 2FL in breast milk, the secretor status of a mother may be determined. Another method of determining the secretor status of a mother is via a simple blood or saliva test. The determination of the secretor status of a mother by either of these methods would be readily apparent to one of ordinary skill in the art. For example, to perform a saliva test, a saliva sample is collected using saliva collection kit and the DNA stabilised using a DNA stabilisation kit. The DNA from the saliva is then genotyped using a reverse transcription polymerase chain reaction (RT-PCR; FUT2 428 position) and analysed using single nucleotide polymorphism (SNP) target of rs516246. The results are then visualised using gel electrophoresis.

The term “enteral” means deliverable through or within the gastrointestinal, or digestive, tract. “Enteral administration” includes oral feeding, intragastric feeding, transpyloric administration, or any other administration into the digestive tract. “Administration” is broader than “enteral administration” and includes parenteral administration or any other route of administration by which a substance is taken into a subject's body.

The term “degree of hydrolysis” refers to the extent to which peptide bonds are broken by a hydrolysis method. The degree of protein hydrolysis for the purposes of characterising the hydrolysed protein component of the nutritional compositions is easily determined by one of ordinary skill in the formulation arts, by quantifying the amino nitrogen to total nitrogen ratio (AN/TN) of the protein component of the selected composition. The amino nitrogen component is quantified by USP titration methods for determining amino nitrogen content, with the total nitrogen component being determined by the Tecator Kjeldahl method. These methods are well-known to one of ordinary skill in the analytical chemistry art.

The term “partially hydrolysed” means having a degree of hydrolysis which is greater than 0% but less than about 50%.

The term “extensively hydrolysed” means having a degree of hydrolysis which is greater than or equal to about 50%.

The term “peptide” describes linear molecular chains of amino acids, including single chain molecules or their fragments. The term “small amino acid peptide”, in terms of this disclosure, means a peptide comprising no more than 50 total amino acids. The small amino acid peptides of the present disclosure may be naturally occurring or they may be synthesised.

The term “substantially free” means containing less than a functional amount of the specified component, typically less than 0.1% by weight, and includes 0% by weight of the specified ingredient.

As applied to nutrients, the term “essential” refers to any nutrient that cannot be synthesised by the body in amounts sufficient for normal growth, so it must be supplied by the diet. The term “conditionally essential” as applied to nutrients means that the nutrient must be supplied by the diet when adequate amounts of the precursor compound is unavailable to the body for endogenous synthesis to occur.

The term “probiotic” refers to microorganisms, such as bacteria or yeast, which have been shown to exert a beneficial effect on the health of a host subject. Probiotics can usually be classified as ‘viable’ or ‘non-viable’. The term ‘viable probiotics’ refers to living microorganisms, with the amount of a viable probiotic being detailed in colony-forming units (CFU). Probiotics that have been heat-killed, or otherwise inactivated, are termed ‘non-viable probiotics’ i.e. non-living microorganisms. Non-viable probiotics may still retain the ability to favourably influence the health of the host even though they may have been heat-killed or otherwise inactivated.

The term “prebiotic” refers to a non-digestible food ingredient that beneficially affects the host by selectively stimulating the growth and/or activity of one or a limited number of bacteria in the digestive tract, which can improve the health of the host. Prebiotics exert health benefits, which may include, but are not limited to: selective stimulation of the growth and/or activity of one or a limited number of beneficial gut bacteria; stimulation of the growth and/or activity of ingested probiotic microorganisms; selective reduction in gut pathogens; and, favourable influence on gut short chain fatty acid profile. The prebiotic of the nutritional compositions may be naturally-occurring, synthetic, or developed through the genetic manipulation of organisms and/or plants, whether such new source is now known or developed later.

The term “organism” refers to any contiguous living system, such as an animal, plant, fungus, or micro-organism.

“Non-human lactoferrin” refers to lactoferrin that is produced by or obtained from a source other than human breast milk.

The term “sialic acid” refers to a family of derivatives of neuraminic acid. N-acetylneuraminic acid (Neu5Ac) and N-glycolylneuraminic acid (Neu5Gc) are among the most abundant, naturally-found forms of sialic acid, especially Neu5Ac in human and cow's milk.

All percentages, parts, and ratios as used herein are detailed by weight of the total composition, unless otherwise specified. All amounts specified as administered “per day” may be delivered in a single unit dose, in a single serving, or in two or more doses or servings administered over the course of a 24 hour period.

All references to singular characteristics or limitations in the present disclosure shall include the corresponding plural characteristic or limitation, and vice versa, unless otherwise specified or clearly implied to the contrary, by the context in which the reference is made.

All combinations of method or process steps disclosed herein can be performed in any order, unless otherwise specified or clearly implied to the contrary, by the context in which the referenced combination is made.

The compositions and methods of the present disclosure can comprise, consist of, or consist essentially of any of the components described herein, as well as including any additional component useful in nutritional compositions.

### DETAILED DESCRIPTION

The present disclosure relates generally to a plurality of nutritional compositions comprising HMOs, for use in providing nutrition to infants at different age stages. The plurality of nutritional compositions may comprise a Stage 1 composition, intended for infants from birth (i.e. 0 months) to 6 months of age (0 to 6 months), and a Stage 2 composition, intended for infants from 6 to 12 months of age. In another aspect, the plurality of nutritional compositions may comprise a Stage A composition, intended for infants from birth (i.e. 0 months) to 3 months of age (0 to 3 months), a Stage B composition, intended for infants from 3 to 6 months of age, and a Stage C composition, intended for infants from 6 to 12 months of age.

The present disclosure relates to age-specific nutritional composition systems for infants comprising human milk oligosaccharides (HMOs). HMOs is the collective term for the group of around 200 complex carbohydrates that are found in human breast milk, with HMOs being the third most abundant solid component of human breast milk.

The present inventors have quantified the levels of seven of the most prominent HMOs in human breast milk, at various different stages of lactation. The present invention therefore provides nutritional compositions comprising HMOs, wherein the HMO composition changes as the infant ages, instead of simply providing a constant level of HMOs throughout an infant's development. The nutritional compositions of the present disclosure can therefore more closely mimic human breast milk at different stages of lactation.

The provision of nutritional compositions wherein the HMO composition changes as the infant ages may: improve gut microbiota composition/activity to resemble breast-fed infant microbiota; beneficially impact development and maturation of the immune system (lower incidence of infections); lead to reduced gut permeability (e.g. improved absorption via action of microbiome); lead to reduced inflammatory factors (modified expression of select immunomodulators and inflammatory cytokines/chemokines); stimulate neurodevelopment (improved learning and memory); and, lead to increased sialic acid in certain brain regions possibly associated with increased free sialic acid in saliva and plasma.

For the sake of clarity, the amounts of the HMOs present in the nutritional compositions of the present disclosure are detailed below in grams per litre (g/L) only. This is not to be deemed as a limitation of the nutritional compositions solely to liquid nutritional compositions; the nutritional compositions of the present disclosure may comprise any of: a reconstitutable powder; a gel; a suspension; a paste; a solid; a liquid; a liquid concentrate; a reconstitutable powdered milk substitute; or, a ready-to-use product.

In one aspect, the present invention provides an age-specific nutritional composition system comprising at least one stage 1 nutritional composition for infants from 0 to 6 months of age; and, at least one stage 2 nutritional composition for infants from 6 to 12 months of age, wherein the stage 1 and stage 2 nutritional compositions comprise HMOs. The HMOs may comprise 2FL, 3FL, LNT, 3SL, and 6SL; alternatively, the HMOs may comprise 3FL, LNT, 3SL, and 6SL. The stage 1 and stage 2 nutritional compositions comprise different amounts of one or more of the human milk oligosaccharides.

Relative to the stage 2 nutritional composition, the stage 1 nutritional composition may comprise a greater amount of 2FL, a smaller amount of 3FL, a greater amount of LNT, a smaller amount of 3SL, a greater amount of 6SL, or any combination thereof.

The stage 1 nutritional composition may comprise 1.5 g/L to 4 g/L of 2FL. Preferably, the stage 1 nutritional composition comprises 1.75 g/L to 3.75 g/L of 2FL. More preferably, the stage 1 nutritional composition comprises 1.8 g/L to 3.6 g/L of 2FL. The stage 2 nutritional composition may comprise 1.3 g/L to 2 g/L of 2FL. Preferably, the stage 2 nutritional composition comprises 1.35 g/L to 1.8 g/L of 2FL. More preferably, the stage 2 nutritional composition comprises 1.4 g/L to 1.7 g/L of 2FL.

The stage 1 nutritional composition may comprise 0.1 g/L to 2 g/L of 3FL. Preferably, the stage 1 nutritional composition comprises 0.5 g/L to 1.5 g/L of 3FL. More preferably, the stage 1 nutritional composition comprises 0.7 g/L to 1.3 g/L of 3FL. The stage 2 nutritional composition may comprise 0.5 g/L to 2.2 g/L of 3FL. Preferably, the stage 2 nutritional composition comprises 0.8 g/L to 1.8 g/L of 3FL. More preferably, the stage 2 nutritional composition comprises 1 g/L to 1.6 g/L of 3FL.

The stage 1 nutritional composition may comprise 1 g/L to 4.2 g/L of LNT. Preferably, the stage 1 nutritional composition comprises 1.6 g/L to 3.6 g/L of LNT. More preferably, the stage 1 nutritional composition comprises 1.8 g/L to 2.8 g/L of LNT. The stage 2 nutritional composition may comprise 0.5 g/L to 17 g/L of LNT. Preferably, the stage 2 nutritional composition comprises 0.7 g/L to 1.6 g/L of LNT. More preferably, the stage 2 nutritional composition comprises 0.9 g/L to 1.4 g/L of LNT.

The stage 1 nutritional composition may comprise 0.01 g/L to 0.2 g/L of 3SL. Preferably, the stage 1 nutritional composition comprises 0.04 g/L to 0.14 g/L of 3SL. More preferably, the stage 1 nutritional composition comprises 0.06 g/L to 0.12 g/L of 3SL. The stage 2 nutritional composition may comprise 0.1 g/L to 0.35 g/L of 3SL. Preferably, the stage 2 nutritional composition comprises 0.14 g/L to 0.3 g/L of 3SL. More preferably, the stage 2 nutritional composition comprises 0.16 g/L to 0.26 g/L of 3SL.

The stage 1 nutritional composition may comprise 0.01 g/L to 0.45 g/L of 6SL. Preferably, the stage 1 nutritional composition comprises 0.05 g/L to 0.35 g/L of 6SL. More preferably, the stage 1 nutritional composition comprises 0.1 g/L to 0.3 g/L of 6SL. The stage 2 nutritional composition may comprise 0.01 g/L to 0.1 g/L of 6SL. Preferably, the stage 2 nutritional composition comprises 0.02 g/L to 0.08 g/L of 6SL. More preferably, the stage 2 nutritional composition comprises 0.03 g/L to 0.07 g/L of 6SL.

The nutritional composition system may comprise stage 1 and stage 2 nutritional compositions comprising:

TABLE 5

| | Stage 1 | Stage 2 |
|---|---|---|
| | (g/L) | (g/L) |
| 2FL | 1.5-4 | 1.3-2 |
| 3FL | 0.1-2 | 0.5-2.2 |
| LNT | 1-4.2 | 0.5-2 |
| 3SL | 0.01-0.2 | 0.1-0.4 |
| 6SL | 0.01-0.45 | 0.01-0.1 |

Optionally, the stage 1 and stage 2 nutritional compositions may comprise lacto-N-neotetraose (LNnT). The stage 1 nutritional composition may comprise 0.01 g/L to 0.5 g/L of LNnT. Preferably, the stage 1 nutritional composition comprises 0.03 g/L to 0.4 g/L of LNnT.

More preferably, the stage 1 nutritional composition comprises 0.05 g/L to 0.35 g/L of LNnT. The stage 2 nutritional composition may comprise 0.01 g/L to 0.1 g/L of LNnT. Preferably, the stage 2 nutritional composition comprises 0.02 g/L to 0.08 g/L of LNnT. More preferably, the stage 2 nutritional composition comprises 0.02 g/L to 0.06 g/L of LNnT.

Optionally, the stage 1 and stage 2 nutritional compositions may comprise lacto-N-fucopentaose I (LNFP I). The stage 1 nutritional composition may comprise 0.1 g/L to 2 g/L of LNFP I. Preferably, the stage 1 nutritional composition comprises 0.2 g/L to 1.8 g/L of LNFP I. More preferably, the stage 1 nutritional composition comprises 0.25 g/L to 1.65 g/L of LNFP I. The stage 2 nutritional composition may comprise 0.05 g/L to 0.3 g/L of LNFP I. Preferably, the stage 2 nutritional composition comprises 0.08 g/L to 0.28 g/L of LNFP I. More preferably, the stage 2 nutritional composition comprises 0.1 g/L to 0.25 g/L of LNFP I.

The amount of α-1,2 fucosylated HMOs (such as 2FL) in human breast milk is dependent on whether the mother has a functional FUT2 allele. A ‘secretor mother’ is a mother who has a functional FUT2 allele and therefore, produces breast milk containing a large amount of α-1,2 fucosylated HMOs. Whereas, a ‘non-secretor mother’ is a mother who has a non-functional FUT2 allele and therefore, produces breast milk containing no, or a minimum level of, α-1,2 fucosylated HMOs.

The nutritional composition system may be specifically designed for an infant of a secretor mother. When the nutritional composition is designed specifically for an infant of a secretor mother, the stage 1 nutritional composition may comprise 1.5 g/L to 4 g/L of 2FL. Preferably, the stage 1 nutritional composition comprises 1.9 g/L to 3.6 g/L of 2FL. More preferably, the stage 1 nutritional composition comprises 2.2 g/L to 3.2 g/L of 2FL. The stage 2 nutritional composition may comprise 1.3 g/L to 2 g/L of 2FL. Preferably, the stage 2 nutritional composition comprises 1.35 g/L to 1.8 g/L of 2FL. More preferably, the stage 2 nutritional composition comprises 1.4 g/L to 1.7 g/L of 2FL.

When the nutritional composition system is designed specifically for an infant of a secretor mother, the stage 1 nutritional composition may comprise 0.1 g/L to 1.2 g/L of 3FL. Preferably, the stage 1 nutritional composition comprises 0.3 g/L to 0.8 g/L of 3FL. More preferably, the stage 1 nutritional composition comprises 0.4 g/L to 0.7 g/L of 3FL. The stage 2 nutritional composition may comprise 0.5 g/L to 1.5 g/L of 3FL. Preferably, the stage 2 nutritional composition comprises 0.6 g/L to 1.4 g/L of 3FL. More preferably, the stage 2 nutritional composition comprises 0.7 g/L to 1.3 g/L of 3FL.

When the nutritional composition system is designed specifically for an infant of a secretor mother, the stage 1 nutritional composition may comprise 0.7 g/L to 2.2 g/L of LNT.

Preferably, the stage 1 nutritional composition comprises 1 g/L to 1.7 g/L of LNT. More preferably, the stage 1 nutritional composition comprises 1.2 g/L to 1.5 g/L of LNT. The stage 2 nutritional composition may comprise 0.5 g/L to 1.3 g/L of LNT. Preferably, the stage 2 nutritional composition comprises 0.6 g/L to 1.2 g/L of LNT. More preferably, the stage 2 nutritional composition comprises 0.7 g/L to 1.1 g/L of LNT.

When the nutritional composition system is designed specifically for an infant of a secretor mother, the stage 1 nutritional composition may comprise 0.01 g/L to 0.2 g/L of 3SL. Preferably, the stage 1 nutritional composition comprises 0.05 g/L to 0.15 g/L of 3SL. More preferably, the stage 1 nutritional composition comprises 0.07 g/L to 0.13 g/L of 3SL. The stage 2 nutritional composition may comprise 0.1 g/L to 0.4 g/L of 3SL. Preferably, the stage 2 nutritional composition comprises 0.14 g/L to 0.34 g/L of 3SL. More preferably, the stage 2 nutritional composition comprises 0.18 g/L to 0.28 g/L of 3SL.

When the nutritional composition system is designed specifically for an infant of a secretor mother, the stage 1 nutritional composition may comprise 0.01 g/L to 0.45 g/L of 6SL. Preferably, the stage 1 nutritional composition comprises 0.1 g/L to 0.35 g/L of 6SL. More preferably, the stage 1 nutritional composition comprises 0.15 g/L to 0.3 g/L of 6SL. The stage 2 nutritional composition may comprise 0.01 g/L to 0.1 g/L of 6SL. Preferably, the stage 2 nutritional composition comprises 0.01 g/L to 0.07 g/L of 6SL. More preferably, the stage 2 nutritional composition comprises 0.02 g/L to 0.05 g/L of 6SL.

The nutritional composition system for an infant of a secretor mother may comprise stage 1 and stage 2 nutritional compositions comprising:

TABLE 6

| | Stage 1 | Stage 2 |
|---|---|---|
| | (g/L) | (g/L) |
| 2FL | 1.5-4 | 1.3-2 |
| 3FL | 0.1-1.2 | 0.5-1.5 |
| LNT | 0.7-2.2 | 0.5-1.3 |
| 3SL | 0.01-0.2 | 0.1-0.4 |
| 6SL | 0.01-0.45 | 0.01-0.1 |

Optionally, when the nutritional composition system is designed specifically for an infant of a secretor mother, the stage 1 nutritional composition may comprise 0.01 g/L to 0.5 g/L of LNnT. Preferably, the stage 1 nutritional composition comprises 0.03 g/L to 0.4 g/L of LNnT. More preferably, the stage 1 nutritional composition comprises 0.05 g/L to 0.35 g/L of LNnT. The stage 2 nutritional composition may comprise 0.01 g/L to 0.1 g/L of LNnT. Preferably, the stage 2 nutritional composition comprises 0.02 g/L to 0.08 g/L of LNnT. More preferably, the stage 2 nutritional composition comprises 0.02 g/L to 0.06 g/L of LNnT.

Optionally, when the nutritional composition system is designed specifically for an infant of a secretor mother, the stage 1 nutritional composition may comprise 0.1 g/L to 2 g/L of LNFP I. Preferably, the stage 1 nutritional composition comprises 0.2 g/L to 1.8 g/L of LNFP I. More preferably, the stage 1 nutritional composition comprises 0.25 g/L to 1.65 g/L of LNFP I. The stage 2 nutritional composition may comprise 0.05 g/L to 0.3 g/L of LNFP I. Preferably, the stage 2 nutritional composition comprises 0.08 g/L to 0.28 g/L of LNFP I. More preferably, the stage 2 nutritional composition comprises 0.1 g/L to 0.25 g/L of LNFP I.

The nutritional composition system may be specifically designed for an infant of a non-secretor mother. When the nutritional composition system is designed specifically for an infant of a non-secretor mother, the stage 1 nutritional composition, stage 2 nutritional composition, or both may comprise no 2FL. Alternatively, when the nutritional composition is designed specifically for an infant of a non-secretor mother, the stage 1 nutritional composition may comprise 1.5 g/L to 4 g/L of 2FL. Preferably, the stage 1 nutritional composition comprises 1.9 g/L to 3.6 g/L of 2FL. More preferably, the stage 1 nutritional composition comprises 2.2 g/L to 3.2 g/L of 2FL. The stage 2 nutritional composition may comprise 1.3 g/L to 2 g/L of 2FL. Preferably, the stage 2 nutritional composition comprises 1.35 g/L to 1.8 g/L of 2FL. More preferably, the stage 2 nutritional composition comprises 1.4 g/L to 1.7 g/L of 2FL.

When the nutritional composition system is designed specifically for an infant of a non-secretor mother, the stage 1 nutritional composition may comprise 0.5 g/L to 2 g/L of 3FL. Preferably, the stage 1 nutritional composition comprises 0.8 g/L to 1.8 g/L of 3FL. More preferably, the stage 1 nutritional composition comprises 1 g/L to 1.5 g/L of 3FL. The stage 2 nutritional composition may comprise 1 g/L to 2.2 g/L of 3FL. Preferably, the stage 2 nutritional composition comprises 1.2 g/L to 2 g/L of 3FL. More preferably, the stage 2 nutritional composition comprises 1.5 g/L to 1.7 g/L of 3FL.

When the nutritional composition system is designed specifically for an infant of a non-secretor mother, the stage 1 nutritional composition may comprise 1 g/L to 4.2 g/L of LNT. Preferably, the stage 1 nutritional composition comprises 1.5 g/L to 3.7 g/L of LNT. More preferably, the stage 1 nutritional composition comprises 1.8 g/L to 3.4 g/L of LNT. The stage 2 nutritional composition may comprise 0.8 g/L to 1.7 g/L of LNT. Preferably, the stage 2 nutritional composition comprises 1 g/L to 1.5 g/L of LNT. More preferably, the stage 2 nutritional composition comprises 1.1 g/L to 1.4 g/L of LNT.

When the nutritional composition system is designed specifically for an infant of a non-secretor mother, the stage 1 nutritional composition may comprise 0.01 g/L to 0.2 g/L of 3SL. Preferably, the stage 1 nutritional composition comprises 0.04 g/L to 0.16 g/L of 3SL. More preferably, the stage 1 nutritional composition comprises 0.06 g/L to 0.14 g/L of 3SL. The stage 2 nutritional composition may comprise 0.1 g/L to 0.25 g/L of 3SL. Preferably, the stage 2 nutritional composition comprises 0.12 g/L to 0.2 g/L of 3SL. More preferably, the stage 2 nutritional composition comprises 0.14 g/L to 0.18 g/L of 3SL.

When the nutritional composition system is designed specifically for an infant of a non-secretor mother, the stage 1 nutritional composition may comprise 0.01 g/L to 0.45 g/L of 6SL. Preferably, the stage 1 nutritional composition comprises 0.05 g/L to 0.4 g/L of 6SL. More preferably, the stage 1 nutritional composition comprises 0.1 g/L to 0.3 g/L of 6SL. The stage 2 nutritional composition may comprise 0.01 g/L to 0.1 g/L of 6SL. Preferably, the stage 2 nutritional composition comprises 0.02 g/L to 0.08 g/L of 6SL. More preferably, the stage 2 nutritional composition comprises 0.02 g/L to 0.06 g/L of 6SL.

The nutritional composition system for an infant of a non-secretor mother may comprise stage 1 and stage 2 nutritional compositions comprising:

TABLE 7

| | Stage 1 | Stage 2 |
|---|---|---|
| | (g/L) | (g/L) |
| 3FL | 0.5-2 | 1-2.2 |
| LNT | 1-4.2 | 0.8-1.7 |
| 3SL | 0.01-0.2 | 0.1-0.25 |
| 6SL | 0.01-0.45 | 0.01-0.1 |

Alternatively, the nutritional composition system for an infant of a non-secretor mother may comprise stage 1 and stage 2 nutritional compositions comprising:

TABLE 8

| | Stage 1 | Stage 2 |
|---|---|---|
| | (g/L) | (g/L) |
| 2FL | 1.5-4 | 1.3-2 |
| 3FL | 0.5-2 | 1-2.2 |
| LNT | 1-4.2 | 0.8-1.7 |
| 3SL | 0.01-0.2 | 0.1-0.25 |
| 6SL | 0.01-0.45 | 0.01-0.1 |

Optionally, when the nutritional composition system is designed specifically for an infant of a non-secretor mother, the stage 1 nutritional composition may comprise 0.01 g/L to 0.5 g/L of LNnT. Preferably, the stage 1 nutritional composition comprises 0.03 g/L to 0.4 g/L of LNnT. More preferably, the stage 1 nutritional composition comprises 0.05 g/L to 0.35 g/L of LNnT. The stage 2 nutritional composition may comprise 0.1 g/L to 0.1 g/L of LNnT. Preferably, the stage 2 nutritional composition comprises 0.02 g/L to 0.08 g/L of LNnT. More preferably, the stage 2 nutritional composition comprises 0.02 g/L to 0.06 g/L of LNnT.

Optionally, when the nutritional composition system is designed specifically for an infant of a non-secretor mother, the stage 1 nutritional composition may comprise 0.1 g/L to 2 g/L of LNFP I. Preferably, the stage 1 nutritional composition comprises 0.2 g/L to 1.8 g/L of LNFP I. More preferably, the stage 1 nutritional composition comprises 0.25 g/L to 1.65 g/L of LNFP I. The stage 2 nutritional composition may comprise 0.05 g/L to 0.3 g/L of LNFP I. Preferably, the stage 2 nutritional composition comprises 0.08 g/L to 0.28 g/L of LNFP I. More preferably, the stage 2 nutritional composition comprises 0.1 g/L to 0.25 g/L of LNFP I.

In another aspect, the present invention provides an age-specific nutritional composition system comprising at least one stage A nutritional composition for infants from 0 to 3 months of age; at least one stage B nutritional composition for infants from 3 to 6 months of age; and, at least one stage C nutritional composition for infants from 6 to 12 months of age, wherein the stage A, stage B, and stage C nutritional compositions comprise HMOs. The HMOs may comprise 2FL, 3FL, LNT, 3SL, and 6SL; alternatively, the HMOs may comprise 3FL, LNT, 3SL, and 6SL. The stage A, stage B, and stage C nutritional compositions each comprise different amounts of one or more of the human milk oligosaccharides.

Relative to the stage B nutritional composition, the stage A nutritional composition may comprise a greater amount of 2FL, a smaller amount of 3FL, a greater amount of LNT, a smaller amount of 3SL, a greater amount of 6SL, or any combination thereof. Relative to the stage C nutritional composition, the stage B nutritional composition comprises a greater amount of 2FL, a smaller amount of 3FL, a greater amount of LNT, a smaller amount of 3SL, a greater amount of 6SL, or any combination thereof.

The stage A nutritional composition may comprise 1.5 g/L to 4 g/L of 2FL. Preferably, the stage A nutritional composition comprises 1.7 g/L to 3.6 g/L of 2FL. More preferably, the stage A nutritional composition comprises 2 g/L to 3.2 g/L of 2FL. The stage B nutritional composition may comprise 1.5 g/L to 2.2 g/L of 2FL. Preferably, the stage B nutritional composition comprises 1.6 g/L to 1.9 g/L of 2FL. More preferably, the stage B nutritional composition comprises 1.65 g/L to 1.85 g/L of 2FL. The stage C nutritional composition may comprise 1.3 g/L to 2 g/L of 2FL. Preferably, the stage C nutritional composition comprises 1.35 g/L to 1.8 g/L of 2FL. More preferably, the stage C nutritional composition comprises 1.4 g/L to 1.7 g/L of 2FL.

The stage A nutritional composition may comprise 0.1 g/L to 1.5 g/L of 3FL. Preferably, the stage A nutritional composition comprises 0.3 g/L to 1.2 g/L of 3FL. More preferably, the stage A nutritional composition comprises 0.4 g/L to 1 g/L of 3FL. The stage B nutritional composition may comprise 0.3 g/L to 2 g/L of 3FL. Preferably, the stage B nutritional composition comprises 0.5 g/L to 1.6 g/L of 3FL. More preferably, the stage B nutritional composition comprises 0.7 g/L to 1.4 g/L of 3FL. The stage C nutritional composition may comprise 0.5 g/L to 2.2 g/L of 3FL. Preferably, the stage C nutritional composition comprises 0.8 g/L to 1.8 g/L of 3FL. More preferably, the stage C nutritional composition comprises 1 g/L to 1.6 g/L of 3FL.

The stage A nutritional composition may comprise 1 g/L to 4.2 g/L of LNT. Preferably, the stage A nutritional composition comprises 1.2 g/L to 3.8 g/L of LNT. More preferably, the stage A nutritional composition comprises 1.4 g/L to 3.4 g/L of LNT. The stage B nutritional composition may comprise 0.7 g/L to 2 g/L of LNT. Preferably, the stage B nutritional composition comprises 0.8 g/L to 1.6 g/L of LNT. More preferably, the stage B nutritional composition comprises 0.9 g/L to 1.4 g/L of LNT. The stage C nutritional composition may comprise 0.5 g/L to 1.7 g/L of LNT. Preferably, the stage C nutritional composition comprises 0.7 g/L to 1.6 g/L of LNT. More preferably, the stage C nutritional composition comprises 0.9 g/L to 1.4 g/L of LNT.

The stage A nutritional composition may comprise 0.01 g/L to 0.15 g/L of 3SL. Preferably, the stage A nutritional composition comprises 0.03 g/L to 0.1 g/L of 3SL. More preferably, the stage A nutritional composition comprises 0.05 g/L to 0.09 g/L of 3SL. The stage B nutritional composition may comprise 0.05 g/L to 0.2 g/L of 3SL. Preferably, the stage B nutritional composition comprises 0.07 g/L to 0.18 g/L of 3SL. More preferably, the stage B nutritional composition comprises 0.09 g/L to 0.15 g/L of 3SL. The stage C nutritional composition may comprise 0.1 g/L to 0.35 g/L of 3SL. Preferably, the stage C nutritional composition comprises 0.14 g/L to 0.3 g/L of 3SL. More preferably, the stage C nutritional composition comprises 0.16 g/L to 0.26 g/L of 3SL.

The stage A nutritional composition may comprise 0.05 g/L to 0.45 g/L of 6SL. Preferably, the stage A nutritional composition comprises 0.1 g/L to 0.4 g/L of 6SL. More preferably, the stage A nutritional composition comprises 0.15 g/L to 0.35 g/L of 6SL. The stage B nutritional composition may comprise 0.01 g/L to 0.18 g/L of 6SL. Preferably, the stage B nutritional composition comprises 0.04 g/L to 0.15 g/L of 6SL. More preferably, the stage B nutritional composition comprises 0.06 g/L to 0.12 g/L of 6SL. The stage C nutritional composition may comprise 0.01 g/L to 0.1 g/L of 6SL. Preferably, the stage C nutritional composition comprises 0.02 g/L to 0.08 g/L of 6SL. More preferably, the stage C nutritional composition comprises 0.03 g/L to 0.06 g/L of 6SL.

The nutritional compositions may comprise stage A, stage B, and stage C nutritional compositions comprise:

TABLE 9

| | Stage A | Stage B | Stage C |
|---|---|---|---|
| | (g/L) | (g/L) | (g/L) |
| 2FL | 1.5-4 | 1.5-2.2 | 1.3-2 |
| 3FL | 0.1-1.5 | 0.3-2 | 0.5-2.2 |
| LNT | 1-4.2 | 0.7-2 | 0.5-1.5 |
| 3SL | 0.01-0.15 | 0.05-0.2 | 0.1-0.35 |
| 6SL | 0.05-0.45 | 0.01-0.18 | 0.01-0.1 |

Optionally, the stage A, stage B, and stage C nutritional compositions may comprise LNnT. The stage A nutritional composition may comprise 0.15 g/L to 0.5 g/L of LNnT. Preferably, the stage A nutritional composition comprises 0.12 g/L to 0.4 g/L of LNnT. More preferably, the stage A nutritional composition comprises 0.1 g/L to 0.35 g/L of LNnT. The stage B nutritional composition may comprise 0.01 g/L to 0.15 g/L of LNnT. Preferably, the stage B nutritional composition comprises 0.03 g/L to 0.12 g/L of LNnT. More preferably, the stage B nutritional composition comprises 0.05 g/L to 0.1 g/L of LNnT. The stage C nutritional composition may comprise 0.01 g/L to 0.5 g/L of LNnT. Preferably, the stage C nutritional composition comprises 0.03 g/L to 0.4 g/L of LNnT. More preferably, the stage C nutritional composition comprises 0.05 g/L to 0.35 g/L of LNnT.

Optionally, the stage A, stage B, and stage C nutritional compositions may comprise LNFP 1. The stage A nutritional composition may comprise 0.45 g/L to 2 g/L of LNFP I. Preferably, the stage A nutritional composition comprises 0.4 g/L to 1.8 g/L of LNFP I. More preferably, the stage A nutritional composition comprises 0.35 g/L to 1.65 g/L of LNFP I. The stage B nutritional composition may comprise 0.15 g/L to 0.45 g/L of LNFP I. Preferably, the stage B nutritional composition comprises 0.2 g/L to 0.4 g/L of LNFP I. More preferably, the stage B nutritional composition comprises 0.25 g/L to 0.35 g/L of LNFP I. The stage C nutritional composition may comprise 0.05 g/L to 0.3 g/L of LNFP I. Preferably, the stage C nutritional composition comprises 0.08 g/L to 0.28 g/L of LNFP I. More preferably, the stage C nutritional composition comprises 0.1 g/L to 0.25 g/L of LNFP I.

The nutritional composition system may be specifically designed for an infant of a secretor mother. When the nutritional composition system is designed specifically for an infant of a secretor mother, the stage A nutritional composition may comprise 1.5 g/L to 4 g/L of 2FL. Preferably, the stage A nutritional composition comprises 1.7 g/L to 3.6 g/L of 2FL. More preferably, the stage A nutritional composition comprises 2 g/L to 3.2 g/L of 2FL. The stage B nutritional composition may comprise 1.5 g/L to 2.2 g/L of 2FL. Preferably, the stage B nutritional composition comprises 1.6 g/L to 1.9 g/L of 2FL. More preferably, the stage B nutritional composition comprises 1.65 g/L to 1.85 g/L of 2FL. The stage C nutritional composition may comprise 1.3 g/L to 2 g/L of 2FL. Preferably, the stage C nutritional composition comprises 1.35 g/L to 1.8 g/L of 2FL. More preferably, the stage C nutritional composition comprises 1.4 g/L to 1.7 g/L of 2FL.

When the nutritional composition system is designed specifically for an infant of a secretor mother, the stage A nutritional composition may comprise 0.1 g/L to 0.7 g/L of 3FL. Preferably, the stage A nutritional composition comprises 0.1 g/L to 0.6 g/L of 3FL. More preferably, the stage A nutritional composition comprises 0.2 g/L to 0.6 g/L of 3FL. The stage B nutritional composition may comprise 0.4 g/L to 1 g/L of 3FL. Preferably, the stage B nutritional composition comprises 0.5 g/L to 0.9 g/L of 3FL. More preferably, the stage B nutritional composition comprises 0.6 g/L to 0.8 g/L of 3FL. The stage C nutritional composition may comprise 0.5 g/L to 1.5 g/L of 3FL. Preferably, the stage C nutritional composition comprises 0.6 g/L to 1.4 g/L of 3FL. More preferably, the stage C nutritional composition comprises 0.7 g/L to 1.3 g/L of 3FL.

When the nutritional composition system is designed specifically for an infant of a secretor mother, the stage A nutritional composition may comprise 1 g/L to 2.2 g/L of LNT. Preferably, the stage A nutritional composition comprises 1.2 g/L to 2 g/L of LNT. More preferably, the stage A nutritional composition comprises 1.3 g/L to 1.8 g/L of LNT, The stage B nutritional composition may comprise 0.7 g/L to 1.5 g/L of LNT. Preferably, the stage B nutritional composition comprises 0.9 g/L to 1.4 g/L of LNT. More preferably, the stage B nutritional composition comprises 1 g/L to 1.2 g/L of LNT. The stage C nutritional composition may comprise 0.5 g/L to 1.3 g/L of LNT. Preferably, the stage C nutritional composition comprises 0.6 g/L to 1.2 g/L of LNT. More preferably, the stage C nutritional composition comprises 0.7 g/L to 1.1 g/L of LNT.

When the nutritional composition system is designed specifically for an infant of a secretor mother, the stage A nutritional composition may comprise 0.01 g/L to 0.15 g/L of 3SL. Preferably, the stage A nutritional composition comprises 0.02 g/L to 0.12 g/L of 3SL. More preferably, the stage A nutritional composition comprises 0.04 g/L to 0.1 g/L of 3SL. The stage B nutritional composition may comprise 0.07 g/L to 0.2 g/L of 3SL. Preferably, the stage B nutritional composition comprises 0.1 g/L to 0.18 g/L of 3SL. More preferably, the stage B nutritional composition comprises 0.12 g/L to 0.16 g/L of 3SL, The stage C nutritional composition may comprise 0.1 g/L to 0.35 g/L of 3SL. Preferably, the stage C nutritional composition comprises 0.14 g/L to 0.34 g/L of 3SL. More preferably, the stage C nutritional composition comprises 0.18 g/L to 0.28 g/L of 3SL.

When the nutritional composition is designed specifically for an infant of a secretor mother, the stage A nutritional composition may comprise 0.05 g/L to 0.45 g/L of 6SL. Preferably, the stage A nutritional composition comprises 0.15 g/L to 0.35 g/L of 6SL. More preferably, the stage A nutritional composition comprises 0.2 g/L to 0.3 g/L of 6SL. The stage B nutritional composition may comprise 0.01 g/L to 0.15 g/L of 6SL. Preferably, the stage B nutritional composition comprises 0.04 g/L to 0.12 g/L of 6SL. More preferably, the stage B nutritional composition comprises 0.06 g/L to 0.1 g/L of 6SL. The stage C nutritional composition may comprise 0.01 g/L to 0.1 g/L of 6SL. Preferably, the stage C nutritional composition comprises 0.01 g/L to 0.07 g/L of 6SL. More preferably, the stage C nutritional composition comprises 0.02 g/L to 0.05 g/L of 6SL.

The nutritional composition system for an infant of a secretor mother may comprise stage A, stage B, and stage C nutritional compositions comprising:

TABLE 10

| | Stage 1 | Stage 2 | Stage 3 |
|---|---|---|---|
| | (g/L) | (g/L) | (g/L) |
| 2FL | 1.5-4 | 1.5-2.2 | 1.3-2 |
| 3FL | 0.1-0.7 | 0.4-1 | 0.5-1.5 |
| LNT | 1-2.2 | 0.7-1.5 | 0.5-1.3 |
| 3SL | 0.01-0.15 | 0.07-0.2 | 0.1-0.35 |
| 6SL | 0.05-0.45 | 0.01-0.15 | 0.01-0.1 |

Optionally, when the nutritional composition system is designed specifically for an infant of a secretor mother, the stage A nutritional composition may comprise 0.15 g/L to 0.5 g/L of LNnT. Preferably, the stage A nutritional composition comprises 0.12 g/L to 0.4 g/L of LNnT. More preferably, the stage A nutritional composition comprises 0.1 g/L to 0.35 g/L of LNnT. The stage B nutritional composition may comprise 0.01 g/L to 0.15 g/L of LNnT. Preferably, the stage B nutritional composition comprises 0.03 g/L to 0.12 g/L of LNnT. More preferably, the stage B nutritional composition comprises 0.05 g/L to 0.1 g/L of LNnT. The stage C nutritional composition may comprise 0.01 g/L to 0.1 g/L of LNnT. Preferably, the stage C nutritional composition comprises 0.02 g/L to 0.08 g/L of LNnT. More preferably, the stage C nutritional composition comprises 0.02 g/L to 0.06 g/L of LNnT.

Optionally, when the nutritional composition system is designed specifically for an infant of a secretor mother, the stage A nutritional composition may comprise 0.45 g/L to 2 g/L of LNFP I. Preferably, the stage A nutritional composition comprises 0.4 g/L to 1.8 g/L of LNFP I. More preferably, the stage A nutritional composition comprises 0.35 g/L to 1.65 g/L of LNFP I. The stage B nutritional composition may comprise 0.15 g/L to 0.45 g/L of LNFP I. Preferably, the stage B nutritional composition comprises 0.2 g/L to 0.4 g/L of LNFP I. More preferably, the stage B nutritional composition comprises 0.25 g/L to 0.35 g/L of LNFP I. The stage C nutritional composition may comprise 0.05 g/L to 0.3 g/L of LNFP I. Preferably, the stage C nutritional composition comprises 0.08 g/L to 0.28 g/L of LNFP I. More preferably, the stage C nutritional composition comprises 0.1 g/L to 0.25 g/L of LNFP I.

The nutritional composition system may be specifically designed for an infant of a non-secretor mother. When the nutritional composition system is designed specifically for an infant of a non-secretor mother, the stage A nutritional composition, the stage B nutritional composition, the stage C nutritional composition, or any combination thereof may comprise no 2FL. Alternatively, when the nutritional composition system is designed specifically for an infant of a non-secretor mother, the stage A nutritional composition may comprise 1.5 g/L to 4 g/L of 2FL. Preferably, the stage A nutritional composition comprises 1.7 g/L to 3.6 g/L of 2FL. More preferably, the stage A nutritional composition comprises 2 g/L to 3.2 g/L of 2FL. The stage B nutritional composition may comprise 1.5 g/L to 2.2 g/L of 2FL. Preferably, the stage B nutritional composition comprises 1.6 g/L to 1.9 g/L of 2FL. More preferably, the stage B nutritional composition comprises 1.65 g/L to 1.85 g/L of 2FL. The stage C nutritional composition may comprise 1.3 g/L to 2 g/L of 2FL. Preferably, the stage C nutritional composition comprises 1.35 g/L to 1.8 g/L of 2FL. More preferably, the stage C nutritional composition comprises 1.4 g/L to 1.7 g/L of 2FL.

When the nutritional composition system is designed specifically for an infant of a non-secretor mother, the stage A nutritional composition may comprise 0.5 g/L to 1.5 g/L of 3FL. Preferably, the stage A nutritional composition comprises 0.7 g/L to 1.3 g/L of 3FL. More preferably, the stage A nutritional composition comprises 0.8 g/L to 1.2 g/L of 3FL. The stage B nutritional composition may comprise 0.7 g/L to 2 g/L of 3FL. Preferably, the stage B nutritional composition comprises 0.9 g/L to 1.8 g/L of 3FL. More preferably, the stage B nutritional composition comprises 1 g/L to 1.6 g/L of 3FL. The stage C nutritional composition may comprise 1.2 g/L to 2 g/L of 3FL. Preferably, the stage C nutritional composition comprises 1.4 g/L to 1.9 g/L of 3FL. More preferably, the stage C nutritional composition comprises 1.5 g/L to 1.8 g/L of 3FL.

When the nutritional composition system is designed specifically for an infant of a non-secretor mother, the stage A nutritional composition may comprise 1 g/L to 4.2 g/L of LNT. Preferably, the stage A nutritional composition comprises 1.4 g/L to 3.7 g/L of LNT. More preferably, the stage A nutritional composition comprises 1.6 g/L to 3.2 g/L of LNT. The stage B nutritional composition may comprise 1 g/L to 1.8 g/L of LNT. Preferably, the stage B nutritional composition comprises 1.2 g/L to 1.7 g/L of LNT. More preferably, the stage B nutritional composition comprises 1.4 g/L to 1.6 g/L of LNT. The stage C nutritional composition may comprise 0.8 g/L to 1.6 g/L of LNT. Preferably, the stage C nutritional composition comprises 0.9 g/L to 1.5 g/L of LNT. More preferably, the stage C nutritional composition comprises 1 g/L to 1.4 g/L of LNT.

When the nutritional composition system is designed specifically for an infant of a non-secretor mother, the stage A nutritional composition may comprise 0.01 g/L to 0.15 g/L of 3SL. Preferably, the stage A nutritional composition comprises 0.04 g/L to 0.12 g/L of 3SL. More preferably, the stage A nutritional composition comprises 0.06 g/L to 0.1 g/L of 3SL. The stage B nutritional composition may comprise 0.05 g/L to 0.18 g/L of 3SL. Preferably, the stage B nutritional composition comprises 0.07 g/L to 0.15 g/L of 3SL. More preferably, the stage B nutritional composition comprises 0.09 g/L to 0.13 g/L of 3SL. The stage C nutritional composition may comprise 0.08 g/L to 0.25 g/L of 3SL. Preferably, the stage C nutritional composition comprises 0.1 g/L to 0.22 g/L of 3SL. More preferably, the stage C nutritional composition comprises 0.12 g/L to 0.18 g/L of 3SL.

When the nutritional composition is designed specifically for an infant of a non-secretor mother, the stage A nutritional composition may comprise 0.08 g/L to 0.45 g/L of 6SL. Preferably, the stage A nutritional composition comprises 0.1 g/L to 0.38 g/L of 6SL. More preferably, the stage A nutritional composition comprises 0.12 g/L to 0.34 g/L of 6SL. The stage B nutritional composition may comprise 0.01 g/L to 0.18 g/L of 6SL. Preferably, the stage B nutritional composition comprises 0.03 g/L to 0.15 g/L of 6SL. More preferably, the stage B nutritional composition comprises 0.05 g/L to 0.13 g/L of 6SL. The stage C nutritional composition may comprise 0.01 g/L to 0.1 g/L of 6SL. Preferably, the stage C nutritional composition comprises 0.02 g/L to 0.08 g/L of 6SL. More preferably, the stage C nutritional composition comprises 0.02 g/L to 0.06 g/L of 6SL.

The nutritional composition system for an infant of a non-secretor mother may comprise stage A, stage B, and stage C nutritional compositions comprising:

TABLE 11

| | Stage 1 | Stage 2 | Stage 3 |
|---|---|---|---|
| | (g/L) | (g/L) | (g/L) |
| 3FL | 0.5-1.5 | 0.7-2 | 1.2-2 |
| LNT | 1-4.2 | 1-1.8 | 0.8-1.6 |
| 3SL | 0.03-0.15 | 0.05-0.18 | 0.08-0.25 |
| 6SL | 0.08-0.45 | 0.01-0.18 | 0.01-0.1 |

The nutritional composition system for an infant of a non-secretor mother may comprise stage A, stage B, and stage C nutritional compositions comprising:

TABLE 12

| | Stage 1 | Stage 2 | Stage 3 |
|---|---|---|---|
| | (g/L) | (g/L) | (g/L) |
| 2FL | 1.5-4 | 1.5-2.2 | 1.3-2 |
| 3FL | 0.5-1.5 | 0.7-2 | 1.2-2 |
| LNT | 1-4.2 | 1-1.8 | 0.8-1.6 |
| 3SL | 0.03-0.15 | 0.05-0.18 | 0.08-0.25 |
| 6SL | 0.08-0.45 | 0.01-0.18 | 0.01-0.1 |

Optionally, when the nutritional composition system is designed specifically for an infant of a non-secretor mother, the stage A nutritional composition may comprise 0.15 g/L to 0.5 g/L of LNnT. Preferably, the stage A nutritional composition comprises 0.12 g/L to 0.4 g/L of LNnT. More preferably, the stage A nutritional composition comprises 0.1 g/L to 0.35 g/L of LNnT. The stage B nutritional composition may comprise 0.01 g/L to 0.15 g/L of LNnT. Preferably, the stage B nutritional composition comprises 0.03 g/L to 0.12 g/L of LNnT. More preferably, the stage B nutritional composition comprises 0.05 g/L to 0.1 g/L of LNnT. The stage C nutritional composition may comprise 0.01 g/L to 0.5 g/L of LNnT. Preferably, the stage C nutritional composition comprises 0.03 g/L to 0.4 g/L of LNnT. More preferably, the stage C nutritional composition comprises 0.05 g/L to 0.35 g/L of LNnT.

Optionally, when the nutritional composition system is designed specifically for an infant of a non-secretor mother, the stage A nutritional composition may comprise 0.45 g/L to 2 g/L of LNFP I. Preferably, the stage A nutritional composition comprises 0.4 g/L to 1.8 g/L of LNFP I. More preferably, the stage A nutritional composition comprises 0.35 g/L to 1.65 g/L of LNFP I. The stage B nutritional composition may comprise 0.15 g/L to 0.45 g/L of LNFP I. Preferably, the stage B nutritional composition comprises 0.2 g/L to 0.4 g/L of LNFP I. More preferably, the stage B nutritional composition comprises 0.25 g/L to 0.35 g/L of LNFP I. The stage C nutritional composition may comprise 0.05 g/L to 0.3 g/L of LNFP I. Preferably, the stage C nutritional composition comprises 0.08 g/L to 0.28 g/L of LNFP I. More preferably, the stage C nutritional composition comprises 0.1 g/L to 0.25 g/L of LNFP I.

A nutritional composition for infants from 0 to 3 months of age may comprise: 1.5 g/L to 4 g/L of 2FL; 0.1 g/L to 1.5 g/L of 3FL; 1 g/L to 4.2 g/L of LNT; 0.01 g/L to 0.15 g/L of 3SL; and, 0.05 g/L to 0.45 g/L of 6SL. Optionally, the nutritional composition for infants from 0 to 3 months of age may also comprise 0.15 g/L to 5 g/L of LNnT, 0.45 g/L to 2 g/L of LNFP I, or both.

A nutritional composition for infants from 0 to 6 months of age may comprise: 1.5 g/L to 4 g/L of 2FL; 0.1 g/L to 2 g/L of 3FL; 1 g/L to 4.2 g/L of LNT; 0.01 g/L to 0.2 g/L of 3SL; and, 0.01 g/L to 0.45 g/L of 6SL. Optionally, the nutritional composition for infants from 0 to 6 months of age may also comprise 0.01 g/L to 0.5 g/L of LNnT, 0.1 g/L to 2 g/L of LNFP I, or both.

A nutritional composition for infants from 3 to 6 months of age may comprise: 1.5 g/L to 2.2 g/L of 2FL; 0.3 g/L to 2 g/L of 3FL; 0.7 g/L to 2 g/L of LNT; 0.05 g/L to 0.2 g/L of 3SL; and, 0.01 g/L to 0.18 g/L of 6SL. Optionally, the nutritional composition for infants from 3 to 6 months of age may also comprise 0.01 g/L to 0.15 g/L of LNnT, 0.15 g/L to 0.45 g/L of LNFP I, or both.

A nutritional composition for infants from 6 to 12 months of age may comprise: 1.3 g/L to 2 g/L of 2FL; 0.5 g/L to 2.2 g/L of 3FL; 0.5 g/L to 1.7 g/L of LNT; 0.1 g/L to 0.35 g/L of 3SL; and, 0.01 g/L to 0.1 g/L of 6SL. Optionally, the nutritional composition for infants from 6 to 12 months of age may also comprise 0.01 g/L to 0.1 g/L of LNnT, 0.05 g/L to 0.3 g/L of LNFP I, or both.

The nutritional compositions may comprise a protein source, a fat or lipid source, a carbohydrate source (in addition to the HMOs disclosed herein), or any combination thereof. The nutritional compositions may comprise one or more: probiotics; prebiotics; source of long chain polyunsaturated fatty acids (LCPUFAs); source of lactoferrin; source of β-glucan; source of sialic acid; suitable nutritional composition ingredient; or, any combination thereof.

The nutritional compositions may comprise at least one protein source, wherein the protein source provides protein to the nutritional compositions. The protein source may comprise intact protein, partially hydrolysed protein, extensively hydrolysed protein, small amino acid peptides, or any combination thereof. The protein source may be present in the nutritional compositions in addition to another protein source, such as lactoferrin. The protein source may be derived from any mammalian animal milk protein or plant protein, as well as their fractions, or any combination thereof. The protein source may comprise bovine milk, caprine milk, whey protein, casein protein, soy protein, rice protein, pea protein, peanut protein, egg protein, sesame protein, fish protein, wheat protein, hydrolysed protein, or any combination thereof. Bovine milk protein sources may comprise, but are not limited to, milk protein powders, milk protein concentrates, milk protein isolates, non-fat milk solids, non-fat milk, non-fat dry milk, whey protein, whey protein isolates, whey protein concentrates, sweet whey, acid whey, casein, acid casein, caseinate (e.g. sodium caseinate, sodium calcium caseinate, calcium caseinate), or any combination thereof.

The nutritional compositions may comprise between about 1 gram and about 7 grams of a protein source per 100 kilocalories (g/100 kcal). Preferably, the nutritional compositions may comprise between about 3.5 g and about 4.5 g of a protein source per 100 kcal. The protein source may comprise from about 40% to about 85% whey protein and from about 15% to about 60% casein.

As noted above, the protein source may comprise a source of intact protein. The nutritional compositions may comprise from about 1 g/100 kcal to about 3 g/100 kcal of intact protein. Preferably, the nutritional composition may comprise from about 1 g/100 kcal to about 2.5 g/100 kcal of intact protein. More preferably, the nutritional composition may comprise from about 1.3 g/100 kcal to about 2.1 g/100 kcal of intact protein. The protein source may comprise a combination of intact protein and partially hydrolysed protein, wherein the partially hydrolysed protein may have a degree of hydrolysis of between about 4% and 10%.

As also noted above, the protein source of the nutritional compositions may comprise partially hydrolysed protein, extensively hydrolysed protein, or a combination thereof. The hydrolysed proteins may be treated with enzymes to break down some or most of the proteins that cause adverse symptoms with the goal of reducing allergic reactions, intolerance, and sensitisation. The proteins may be hydrolysed by any method known in the art. The terms “protein hydrolysates” or “hydrolysed protein” are used interchangeably herein and refer to hydrolysed proteins, wherein the degree of hydrolysis may be from about 20% to about 80%, or from about 30% to about 80%, or even from about 40% to about 60%.

The nutritional compositions may be substantially free of protein and may comprise free amino acids as a protein equivalent source. The amino acids may comprise histidine, isoleucine, leucine, lysine, methionine, cysteine, phenylalanine, tyrosine, threonine, tryptophan, valine, alanine, arginine, asparagine, aspartic acid, glutamic acid, glutamine, glycine, proline, serine, carnitine, taurine, or any combination thereof. The amino acids may be branched chain amino acids. The amount of free amino acids in the nutritional compositions may vary from about 1 to about 5 g/100 kcal. The free amino acids may all have a molecular weight of less than 500 Da. As the nutritional compositions may be substantially free of protein and thus, devoid of the proteins that cause adverse symptoms, the nutritional compositions may be hypoallergenic.

The nutritional compositions may comprise an enriched milk product. The enriched milk product may be formed by fractionation of non-human (e.g. bovine) milk. The enriched milk product may have a total protein level in a range of between 20% and 90%; preferably, the enriched milk product may have a total protein level in a range of between 65% and 80%.

The enriched milk product may comprise an enriched whey protein concentrate (eWPC). Alternatively, the enriched milk product may comprise an enriched lipid fraction derived from milk. The eWPC and the enriched lipid fraction may be produced by any number of fractionation techniques well known in the art. These techniques include, but are not limited to, melting point fractionation, organic solvent fractionation, super critical fluid fractionation, or any combination thereof. Alternatively, eWPC is available commercially, including under the trade names Lacprodan MFGM-10 and Lacprodan PL-20, both available from Arla Food Ingredients of Viby, Denmark. With the addition of eWPC, the lipid composition of nutritional compositions can more closely resemble that of human milk.

The eWPC may be included in the nutritional compositions at a level of about 0.5 g/L to about 10 g/L. Preferably, the eWPC may be present at a level of about 1 g/L to about 9 g/L. More preferably, the eWPC may be present in the nutritional compositions at a level of about 3 g/L to about 8 g/L. Alternatively, the eWPC may be included in the nutritional compositions at a level of about 0.06 g/100 kcal to about 1.5 g/100 kcal. Preferably, the eWPC may be present in the nutritional compositions at a level of about 0.3 g/100 kcal to about 1.4 g/100 kcal. More preferably, the eWPC may be present in the nutritional compositions at a level of about 0.4 g/100 kcal to about 1 g/100 kcal.

The nutritional compositions may comprise at least one fat or lipid source, wherein the fat or lipid source provides fat and/or lipid to the nutritional compositions. Suitable fat or lipid sources for the nutritional compositions may be any known or used in the art. The fat or lipid source may be present in the nutritional compositions in addition to another fat or lipid source, such as a LCPUFA. The fat or lipid source may comprise animal sources, such as milk fat, butter, butter fat, or egg yolk lipid; marine sources, such as fish oils, marine oils, or single cell oils; vegetable and plant oils, such as corn oil, canola oil, sunflower oil, soybean oil, palm olein oil, coconut oil, high oleic sunflower oil, evening primrose oil, rapeseed oil, olive oil, flaxseed (linseed) oil, cottonseed oil, high oleic safflower oil, palm stearin, palm kernel oil, or wheat germ oil; medium chain triglyceride oils; emulsions and esters of fatty acids; or any combination thereof.

The nutritional compositions may comprise between about 1 g/100 kcal to about 10 g/100 kcal of a fat or lipid source. Preferably, the nutritional compositions may comprise between about 2 g/100 kcal to about 7 g/100 kcal of a fat or lipid source. More preferably, the nutritional compositions may comprise between about 2.5 g/100 kcal to about 6 g/100 kcal of a fat or lipid source. Most preferably, the nutritional compositions may comprise between about 3 g/100 kcal to about 4 g/100 kcal of a fat or lipid source.

The nutritional compositions may comprise at least one carbohydrate source, wherein the carbohydrate source provides carbohydrate to the nutritional compositions. The carbohydrate source may be present in the nutritional compositions in addition to another carbohydrate source, such as PDX and GOS. The carbohydrate source may comprise lactose, glucose, fructose, maltodextrins, sucrose, starch, maltodextrin, maltose, fructooligosaccharides, corn syrup, high fructose corn syrup, dextrose, corn syrup solids, rice syrup solids, or any combination thereof. Moreover, hydrolysed, partially hydrolysed, and/or extensively hydrolysed carbohydrates may be desirable for inclusion in the nutritional compositions due to their easy digestibility. More specifically, hydrolysed carbohydrates are less likely to contain allergenic epitopes. The nutritional compositions may therefore comprise a carbohydrate source comprising hydrolysed or intact, naturally or chemically modified, starches sourced from corn, tapioca, rice, or potato, in waxy or non-waxy forms, such as hydrolysed corn starch.

The amount of the carbohydrate source in the nutritional compositions may be between about 5 g and about 25 g/100 kcal. Preferably, the amount of carbohydrate source may be between about 6 g and about 22 g/100 kcal. More preferably, the amount of carbohydrate source may be between about 12 g and about 14 g/100 kcal.

The nutritional compositions may comprise one or more probiotics. The probiotic may comprise any Bifidobacterium species, any Lactobacillus species, or a combination thereof. Preferably, the probiotic comprises Bifidobacterium adolescentis (ATCC number 15703), Bifidobacterium animalis subsp. lactis, Bifidobacterium breve, Bifidobacterium longum subsp. infantis (B. infantis), Lactobacillus acidophilus, Lactobacillus gasseri (ATCC number 33323), Lactobacillus reuteri (DSM number 17938), Lactobacillus rhamnosus GG (LGG; ATCC number 53103), or any combination thereof. More preferably, the probiotic comprises LGG or B. infantis, or a combination thereof. Most preferably, the probiotic comprises B. infantis.

The probiotic may be viable or non-viable. The probiotic incorporated into the nutritional compositions may comprise both viable colony-forming units and non-viable probiotic cell-equivalents. The probiotic may be naturally-occurring, synthetic, or developed through the genetic manipulation of organisms, whether such source is now known or later developed.

The amount of viable probiotic in the nutritional compositions may vary from about 1×10⁴ CFU to about 1.5×10¹² CFU of probiotic(s) per 100 kcal. Preferably, the amount of viable probiotic may be from about 1×10⁶ CFU to about 1×10⁹ CFU of probiotic(s) per 100 kcal. More preferably, the amount of viable probiotic may vary from about 1×10⁷ CFU to about 1×10⁸ CFU of probiotic(s) per 100 kcal.

The nutritional compositions may comprise one or more prebiotics. The prebiotic may comprise oligosaccharides, polysaccharides, or any other prebiotics that comprise fructose, xylose, soya, galactose, glucose, mannose, or any combination thereof. More specifically, the prebiotic may comprise polydextrose (PDX), polydextrose powder, lactulose, lactosucrose, raffinose, glucooligosaccharides, inulin, fructooligosaccharides, isomaltooligosaccharides, soybean oligosaccharides, lactosucrose, xylooligosaccharides, chitooligosaccharides, mannooligosaccharides, aribino-oligosaccharides, sialyloligosaccharides, fucooligosaccharides, galactooligosaccharides (GOS), and gentiooligosaccharides.

The total amount of prebiotic present in the nutritional compositions may be from about 1.0 g/L to about 10.0 g/L of the nutritional compositions. Preferably, the total amount of prebiotic present in the nutritional compositions may be from about 2.0 g/L and about 8.0 g/L of the nutritional compositions. Alternatively, the total amount of prebiotic present in the nutritional compositions may be from about 0.01 g/100 kcal to about 1.5 g/100 kcal. Preferably, the total amount of prebiotic present in the nutritional compositions may be from about 0.15 g/100 kcal to about 1.5 g/100 kcal.

Preferably, the nutritional compositions may comprise a prebiotic comprising PDX, GOS, or a combination thereof.

The amount of PDX in the nutritional compositions may be within the range of from about 1.0 g/L and 10.0 g/L. Preferably, the nutritional compositions may contain an amount of PDX that is between about 2.0 g/L and 8.0 g/L. The amount of PDX in the nutritional compositions may be within the range of from about 0.015 g/100 kcal to about 1.5 g/100 kcal. Preferably, the amount of PDX may be within the range of from about 0.2 g/100 kcal to about 0.6 g/100 kcal. Alternatively, the amount of PDX in the nutritional compositions may be from about 0.05 g/100 kcal to about 1.5 g/100 kcal.

The amount of GOS in the nutritional compositions may be from about 0.015 g/100 kcal to about 1.0 g/100 kcal. The amount of GOS in the nutritional compositions may be from about 0.2 g/100 kcal to about 0.5 g/100 kcal.

Preferably, the nutritional compositions comprise PDX in combination with GOS. Advantageously, the combination of PDX and GOS may stimulate and/or enhance endogenous butyrate production by microbiota. The nutritional compositions may comprise GOS and PDX in a total amount of at least about 0.015 g/100 kcal. The nutritional compositions may comprise GOS and PDX in a total amount of about 0.015 g/100 kcal to about 1.5 g/100 kcal. Preferably, the nutritional compositions may comprise GOS and PDX in a total amount of from about 0.1 g/100 kcal to about 1.0 g/100 kcal. The prebiotic may comprise at least 20% weight per weight (w/w) PDX, GOS, or a combination thereof.

The nutritional compositions may comprise a source of long-chain polyunsaturated fatty acids (LCPUFAs). The source of LCPUFAs may comprise docosahexaenoic acid (DHA), α-linoleic acid, γ-linoleic acid, linoleic acid, linolenic acid, eicosapentaenoic acid (EPA), arachidonic acid (ARA), or any combination thereof. Preferably, the nutritional compositions comprise a source of LCPUFAs comprising DHA, ARA, or a combination thereof.

The amount of LCPUFA in the nutritional compositions may be at least about 5 mg/100 kcal. The nutritional compositions may comprise LCPUFA in amount from about 5 mg/100 kcal to about 100 mg/100 kcal. Preferably, the nutritional compositions may comprise LCPUFA in amount from about 10 mg/100 kcal to about 50 mg/100 kcal.

The nutritional compositions may comprise about 5 mg/100 kcal to about 80 mg/100 kcal of DHA. Preferably, the nutritional compositions may comprise about 10 mg/100 kcal to about 20 mg/100 kcal of DHA. More preferably, the nutritional compositions may comprise about 15 mg/100 kcal to about 20 mg/100 kcal of DHA.

The nutritional compositions may comprise about 10 mg/100 kcal to about 100 mg/100 kcal of ARA. Preferably, the nutritional compositions may comprise about 15 mg/100 kcal to about 70 mg/100 kcal of ARA. More preferably, the nutritional compositions may comprise about 20 mg/100 kcal to about 40 mg/100 kcal of ARA.

The nutritional compositions may comprise both DHA and ARA. The weight ratio of ARA:DHA may be between about 1:3 and about 9:1. Preferably, the ratio of ARA:DHA may be from about 1:2 to about 4:1. The nutritional compositions may comprise oils containing DHA and/or ARA. If utilised, the source of DHA and/or ARA may be any source known in the art such as marine oil, fish oil, single cell oil, egg yolk lipid, or brain lipid. The DHA and ARA may be sourced from single cell Martek oils, DHASCO® and ARASCO®, or variations thereof. The DHA and ARA may be in a natural form, provided that the remainder of the LCPUFA source does not result in any substantial deleterious effect on the infant. Alternatively, the DHA and ARA may be used in refined form.

The nutritional compositions may comprise lactoferrin. The lactoferrin may comprise human lactoferrin produced by a genetically modified organism, non-human lactoferrin, or a combination thereof. The non-human lactoferrin may comprise bovine lactoferrin (bLF), porcine lactoferrin, equine lactoferrin, buffalo lactoferrin, goat lactoferrin, murine lactoferrin, or camel lactoferrin.

Lactoferrin may be present in the composition in an amount of at least about 15 mg/100 kcal. The composition may comprise between about 15 and about 300 mg lactoferrin per 100 kcal. Preferably, the composition may comprise lactoferrin in an amount of from about 60 mg to about 150 mg/100 kcal. More preferably, the composition may comprise about 60 mg to about 100 mg lactoferrin per 100 kcal.

The composition may comprise lactoferrin in an amount of about 0.5 mg to about 1.5 mg per millilitre of formula. Preferably, lactoferrin may be present in quantities of from about 0.6 mg to about 1.3 mg per millilitre of formula. Alternatively, the composition may comprise between about 0.1 g and about 2 g lactoferrin per litre. Preferably, the composition comprises between about 0.6 g and about 1.5 g lactoferrin per litre of formula.

The composition may comprise a source of β-glucan. The source of β-glucan may comprise β-1,3-glucan. Preferably, the β-1,3-glucan may be β-1,3; 1,6-glucan. The amount of β-glucan present in the composition may be at between about 0.010 and about 0.080 g per 100 g of composition. The amount of β-glucan in the composition may be between about 3 mg and about 17 mg per 100 kcal. Preferably, the amount of β-glucan may be between about 6 mg and about 17 mg per 100 kcal.

The nutritional compositions may comprise sialic acid. Mammalian brain tissue contains the highest levels of sialic acid as sialic acid is incorporated into brain-specific proteins, such as the neural cell adhesion molecule (NCAM) and lipids (e.g. gangliosides). Sialic acid is therefore believed to play an important role in neural development and function, learning, cognition, and memory.

The nutritional compositions may comprise sialic acid provided by an inherent source (such as eWPC), exogenous sialic acid, sialic acid from sources (such as cGMP), or any combination thereof. The nutritional compositions may comprise sialic acid at a level of about 100 mg/L to about 800 mg/L. Preferably, sialic acid is present at a level of about 120 mg/L to about 600 mg/L. More preferably, sialic acid is present at a level of about 140 mg/L to about 500 mg/L. Alternatively, sialic acid may be present in an amount from about 1 mg/100 kcal to about 120 mg/100 kcal. Preferably, sialic acid may be present in an amount from about 14 mg/100 kcal to about 90 mg/100 kcal. More preferably, sialic acid may be present in an amount from about 15 mg/100 kcal to about 75 mg/100 kcal.

The nutritional compositions may comprise one or more suitable nutritional composition ingredient, wherein the suitable nutritional composition ingredient comprises choline, inositol, an emulsifier, a preservative, a stabiliser, or a combination thereof. The nutritional compositions may comprise choline. Choline is a nutrient that is essential for normal function of cells. Choline is a precursor for membrane phospholipids and it accelerates the synthesis and release of acetylcholine, a neurotransmitter involved in memory storage. Without wishing to be bound by theory, it is believed that dietary choline and docosahexaenoic acid (DHA) act synergistically to promote the biosynthesis of phosphatidylcholine and thus, help promote synaptogenesis in human subjects. Additionally, choline and DHA act synergistically to promote dendritic spine formation, which is important in the maintenance of established synaptic connections. The nutritional compositions may comprise about 20 mg to about 100 mg of choline per 8 fl. oz. (236.6 mL) serving.

The nutritional compositions may comprise inositol. The inositol may be present as exogenous inositol, inherent inositol, or a combination thereof. The nutritional compositions may comprise between about 10 mg/100 kcal and 40 mg/100 kcal. Preferably, the nutritional compositions comprise between about 20 mg/100 kcal and 40 mg/100 kcal. Alternatively, the composition may comprise between about 200 mg/L and about 300 mg/L.

The composition may comprise one or more emulsifier, as an emulsifier can increase the stability of the composition. The emulsifier may comprise, but is not limited to, egg lecithin, soy lecithin, alpha lactalbumin, monoglycerides, diglycerides, or any combination thereof. The composition may comprise from about 0.5 wt % to about 1 wt % of emulsifier, based on the total dry weight of the composition. Preferably, the composition may comprise from about 0.7 wt % to about 1 wt % of emulsifier based on the total dry weight of the composition.

The composition may comprise one or more preservative, as a preservative can extend the shelf-life of the composition. The preservative may comprise, but is not limited to, potassium sorbate, sodium sorbate, potassium benzoate, sodium benzoate, calcium disodium EDTA, or any combination thereof. The composition may comprise from about 0.1 wt % to about 1.0 wt % of a preservative based on the total dry weight of the composition. Preferably, the composition may comprise from about 0.4 wt % to about 0.7 wt % of a preservative, based on the total dry weight of the composition.

The composition may comprise one or more stabiliser, as a stabiliser can help preserve the structure of the composition. The stabiliser may comprise, but is not limited to, gum arabic, gum ghatti, gum karaya, gum tragacanth, agar, furcellaran, guar gum, gellan gum, locust bean gum, pectin, low methoxyl pectin, gelatine, microcrystalline cellulose, CMC (sodium carboxymethylcellulose), methylcellulose hydroxypropyl methyl cellulose, hydroxypropyl cellulose, DATEM (diacetyl tartaric acid esters of mono- and diglycerides), dextran, carrageenans, or any combination thereof.

The composition may be provided in any form known in the art. The composition may take the form of a powder, a gel, a suspension, a paste, a solid, a liquid, a liquid concentrate, a reconstitutable powdered milk substitute, or a ready-to-use product. Preferably, the composition may take the form of a powder, a liquid concentrate, or a ready-to-use product. More preferably, the composition may be provided in a powder form. Most preferably, the composition is provided in a reconstitutable powder form. When the composition is provided in a powder form, the powder may have a particle size in the range of 5 μm to 1500 μm. When the composition is provided in a powder form, the particle size is preferably in the range of 10 μm to 300 μm.

The composition may be intended for a paediatric subject or an adult. The paediatric subject may be an infant or a child. The infant may be a vaginally-delivered infant. Alternatively, the infant may be an infant delivered by C-section. The gut microbiota play a significant role in the development and maturation of the immune system. It is known that the gut microbiota of C-section infants is different to infants that were vaginally delivered, with a study showing that C-section birth is associated with an increased likelihood of immune and metabolic disorders such as allergies, asthma, hypertension, and obesity (Hansen et al., J Immunol Aug. 1, 2014, 193 (3) 1213-1222). One possible way of reducing the likelihood of immune and metabolic disorders in C-section infants may be the provision of a composition comprising beneficial probiotics such as LGG and B. infantis, in an attempt to bring the gut microbiota of the C-section infants into closer alignment with the gut microbiota of vaginally-delivered infants. The composition of the present application, where the viability of beneficial probiotics such as LGG and B. infantis is increased due to the presence of MFGM, may therefore be particularly advantageous for C-section infants.

The composition may comprise a nutritional supplement, an adult's nutritional product, a children's nutritional product, an infant formula, a human milk fortifier, a young child milk, or any other composition designed for an infant or a paediatric subject. The composition may be provided in an orally-ingestible form, wherein the orally-ingestible comprises a food, a beverage, a tablet, a capsule, or a powder.

The composition may be expelled directly into a subject's intestinal tract. The composition may be expelled directly into the gut. The composition may be formulated to be consumed or administered enterally under the supervision of a physician.

The composition may be delivered to an infant from birth until a time that matches full-term gestation. Alternatively, the composition may be delivered to an infant from birth until at least about three months corrected age, until at least about six months corrected age, or until at least about one-year corrected age. In another aspect, the composition may be delivered to a subject as long as is necessary to correct nutritional deficiencies.

The composition may be suitable for a number of dietary requirements. The composition may be kosher. The composition may be a non-genetically modified product. The composition may be sucrose-free. The composition may also be lactose-free. The composition may not contain any medium-chain triglyceride oil. No carrageenan may be present in the composition. The composition may be free of all gums.

The scope of the present invention is defined in the appended claims. It is to be understood that the skilled person may make amendments to the scope of the claims without departing from the scope of the present disclosure.

### DESCRIPTION OF FIGURES

FIG. 1: Plot of how neutral HMO concentration changes over time in the breast milk of: a) secretor mothers; b) non-secretor mothers.

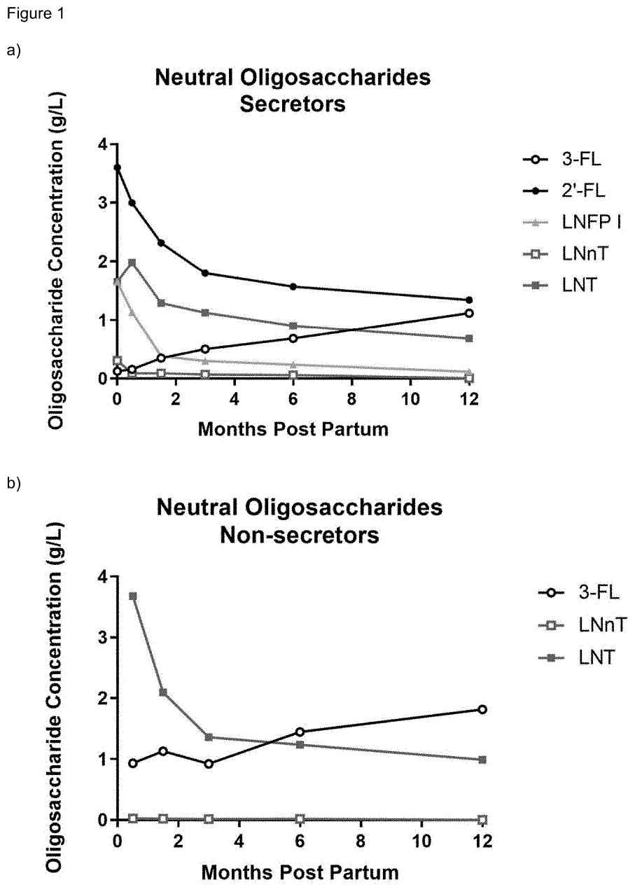

FIG. 2: Plot of how acidic HMO concentration changes over time in the breast milk of: a) secretor mothers; b) non-secretor mothers.

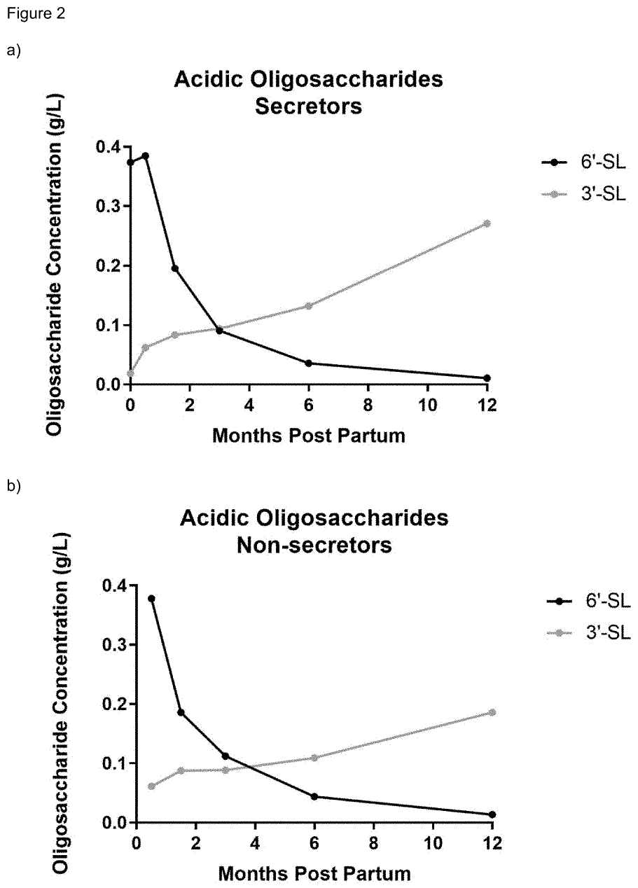

### EXPERIMENTAL PROCEDURE

### Sample Collection/Study Details

94 mother-infant pairs were recruited from a single maternity hospital as part of the Cambridge Baby Growth Study (CBGS). All infants were vaginally born and exclusively breastfed until at least 6 weeks of age. Other inclusion criteria were: singleton; term gestation; no antibiotic and steroid history at least in the 30 days before delivery, no significant maternal illness, no regular use of probiotics during pregnancy; and, normal maternal pre-pregnancy BMI. 91.5% of study participants were Caucasian. The study was approved by the Cambridge Local Research Ethics Committee, and all mothers gave written consent. Breastfed mothers were asked to hand express hind milk samples after feeding their infants at 2 weeks, 6 weeks, 3 months, 6 months, and 12 months postnatally. Expression was done from the same breast last used to feed their infants. Samples were kept frozen until processed at a single time point.

### HMO Level Quantification

Five neutral HMOs (3-fucosyllactose, 2-fucosyllactose, lacto-N-fucopentaose I, lacto-N-tetraose, and lacto-N-neotetraose) and two acidic HMOs (6-sialyllactose and 3-sialyllactose) were quantified in 164 human hind milk samples, originating from 71 healthy lactating mothers. Quantification was conducted by high-performance anion-exchange chromatography with pulsed amperometric detection, using an expedited ‘dilute-and-shoot’ on-line sample clean-up method.

### Example Compositions

The below compositions are to be illustrate some Examples of nutritional compositions within the scope of the present disclosure, but are in no way intended to provide any limitation on the disclosure.

TABLE 13

| Component | Nutritional composition for 0 to 3 months of age | | | | | | | | | |
|---|---|---|---|---|---|---|---|---|---|---|
| (Amount (g/L)) | I | II | III | IV | V | VI | VII | VIII | IX | X |
| 2FL (1.5-4) | X | ✓ | ✓ | ✓ | ✓ | ✓ | ✓ | ✓ | ✓ | ✓ |
| 3FL (0.1-1.5) | ✓ | ✓ | ✓ | ✓ | ✓ | ✓ | ✓ | ✓ | ✓ | ✓ |
| LNT (1-4.2) | ✓ | ✓ | ✓ | ✓ | ✓ | ✓ | ✓ | ✓ | ✓ | ✓ |
| 3SL (0.01-0.15) | ✓ | ✓ | ✓ | ✓ | ✓ | ✓ | ✓ | ✓ | ✓ | ✓ |
| 6SL (0.05-0.45) | ✓ | ✓ | ✓ | ✓ | ✓ | ✓ | ✓ | ✓ | ✓ | ✓ |
| LGG | X | X | ✓ | X | X | X | X | X | X | ✓ |
| B. infantis | X | X | X | ✓ | X | X | X | X | X | ✓ |
| PDX | X | X | X | X | ✓ | X | X | X | ✓ | ✓ |
| GOS | X | X | X | X | ✓ | X | X | X | ✓ | ✓ |
| DHA | X | X | X | X | X | ✓ | ✓ | X | ✓ | ✓ |
| ARA | X | X | X | X | X | X | ✓ | X | ✓ | ✓ |
| Lactoferrin | X | X | X | X | X | X | X | ✓ | X | ✓ |

Key:
✓ = present;
X = not present

TABLE 14

| Component | Nutritional composition for 0 to 6 months of age | | | | | | | | | |
|---|---|---|---|---|---|---|---|---|---|---|
| (Amount (g/L)) | I | II | III | IV | V | VI | VII | VIII | IX | X |
| 2FL (1.5-4) | X | ✓ | ✓ | ✓ | ✓ | ✓ | ✓ | ✓ | ✓ | ✓ |
| 3FL (0.1-2) | ✓ | ✓ | ✓ | ✓ | ✓ | ✓ | ✓ | ✓ | ✓ | ✓ |
| LNT (1-4.2) | ✓ | ✓ | ✓ | ✓ | ✓ | ✓ | ✓ | ✓ | ✓ | ✓ |
| 3SL (0.01-0.2) | ✓ | ✓ | ✓ | ✓ | ✓ | ✓ | ✓ | ✓ | ✓ | ✓ |
| 6SL (0.01-0.45) | ✓ | ✓ | ✓ | ✓ | ✓ | ✓ | ✓ | ✓ | ✓ | ✓ |
| LGG | X | X | ✓ | X | X | X | X | X | X | ✓ |
| B. infantis | X | X | X | ✓ | X | X | X | X | X | ✓ |
| PDX | X | X | X | X | ✓ | X | X | X | ✓ | ✓ |
| GOS | X | X | X | X | ✓ | X | X | X | ✓ | ✓ |
| DHA | X | X | X | X | X | ✓ | ✓ | X | ✓ | ✓ |
| ARA | X | X | X | X | X | X | ✓ | X | ✓ | ✓ |
| Lactoferrin | X | X | X | X | X | X | X | ✓ | X | ✓ |

Key:
✓ = present;
X = not present

TABLE 15

| Component | Nutritional composition for 3 to 6 months of age | | | | | | | | | |
|---|---|---|---|---|---|---|---|---|---|---|
| (Amount (g/L)) | I | II | III | IV | V | VI | VII | VIII | IX | X |
| 2FL (1.5-2.2) | X | ✓ | ✓ | ✓ | ✓ | ✓ | ✓ | ✓ | ✓ | ✓ |
| 3FL (0.3-2) | ✓ | ✓ | ✓ | ✓ | ✓ | ✓ | ✓ | ✓ | ✓ | ✓ |
| LNT (0.7-2) | ✓ | ✓ | ✓ | ✓ | ✓ | ✓ | ✓ | ✓ | ✓ | ✓ |
| 3SL (0.05-0.2) | ✓ | ✓ | ✓ | ✓ | ✓ | ✓ | ✓ | ✓ | ✓ | ✓ |
| 6SL (0.01-0.18) | ✓ | ✓ | ✓ | ✓ | ✓ | ✓ | ✓ | ✓ | ✓ | ✓ |
| LGG | X | X | ✓ | X | X | X | X | X | X | ✓ |
| B. infantis | X | X | X | ✓ | X | X | X | X | X | ✓ |
| PDX | X | X | X | X | ✓ | X | X | X | ✓ | ✓ |
| GOS | X | X | X | X | ✓ | X | X | X | ✓ | ✓ |
| DHA | X | X | X | X | X | ✓ | ✓ | X | ✓ | ✓ |
| ARA | X | X | X | X | X | X | ✓ | X | ✓ | ✓ |
| Lactoferrin | X | X | X | X | X | X | X | ✓ | X | ✓ |

Key:
✓ = present;
X = not present

TABLE 16

| Component | Nutritional composition for 6 to 12 months of age | | | | | | | | | |
|---|---|---|---|---|---|---|---|---|---|---|
| (Amount (g/L)) | I | II | III | IV | V | VI | VII | VIII | IX | X |
| 2FL (1.3-2) | X | ✓ | ✓ | ✓ | ✓ | ✓ | ✓ | ✓ | ✓ | ✓ |
| 3FL (0.5-2.2) | ✓ | ✓ | ✓ | ✓ | ✓ | ✓ | ✓ | ✓ | ✓ | ✓ |
| LNT (0.5-1.7) | ✓ | ✓ | ✓ | ✓ | ✓ | ✓ | ✓ | ✓ | ✓ | ✓ |
| 3SL (0.1-0.35) | ✓ | ✓ | ✓ | ✓ | ✓ | ✓ | ✓ | ✓ | ✓ | ✓ |
| 6SL (0.01-0.1) | ✓ | ✓ | ✓ | ✓ | ✓ | ✓ | ✓ | ✓ | ✓ | ✓ |
| LGG | X | X | ✓ | X | X | X | X | X | X | ✓ |
| B. infantis | X | X | X | ✓ | X | X | X | X | X | ✓ |
| PDX | X | X | X | X | ✓ | X | X | X | ✓ | ✓ |
| GOS | X | X | X | X | ✓ | X | X | X | ✓ | ✓ |
| DHA | X | X | X | X | X | ✓ | ✓ | X | ✓ | ✓ |
| ARA | X | X | X | X | X | X | ✓ | X | ✓ | ✓ |
| Lactoferrin | X | X | X | X | X | X | X | ✓ | X | ✓ |

Key:
✓ = present;
X = not present

1. An age-specific nutritional composition system comprising:
at least one stage 1 nutritional composition for infants from 0 to 6 months of age; and,
at least one stage 2 nutritional composition for infants from 6 to 12 months of age,
wherein the stage 1 and stage 2 nutritional compositions comprise human milk oligosaccharides,
wherein the human milk oligosaccharides comprise 2′-fucosyllactose (2FL), 3′-fucosyllactose (3FL), lacto-N-tetraose (LNT), 6′-sialyllactose (6SL), and 3′-sialyllactose (3SL), and
wherein the stage 1 and stage 2 nutritional compositions comprise different amounts of one or more of the human milk oligosaccharides.

2. The nutritional composition system of claim 1, wherein, relative to the stage 2 nutritional composition, the stage 1 nutritional composition comprises a greater amount of 2FL, a smaller amount of 3FL, a greater amount of LNT, a smaller amount of 3 SL, a greater amount of 6SL, or any combination thereof.

3. The nutritional composition system of claim 1, wherein the stage 1 and stage 2 nutritional compositions comprise:

| | Stage 1 (g/L) | Stage 2 (g/L) |
|---|---|---|
| 2FL | 1.5-4 | 1.3-2 |
| 3FL | 0.1-2 | 0.5-2.2 |
| LNT | 1-4.2 | 0.5-1.7 |
| 3SL | 0.01-0.2 | 0.1-0.35 |
| 6SL | 0.01-0.45 | 0.01-0.1 |

4-7. (canceled)

8. The nutritional composition system of claim 1, wherein at least one of the nutritional compositions comprises a long-chain polyunsaturated fatty acid, preferably the long-chain polyunsaturated fatty acid comprises docosahexaenoic acid, arachidonic acid, or a combination thereof.

9. The nutritional composition system of claim 1, wherein at least one of the nutritional compositions comprises a probiotic, preferably the probiotic comprises Bifidobacterium longum subsp. infantis, Lactobacillus rhamnosus GG (ATCC number 53103), or a combination thereof.

10. The nutritional composition system of claim 1, wherein at least one of the nutritional compositions comprises a prebiotic, preferably the prebiotic comprises polydextrose, galactooligosaccharides, or a combination thereof.

11. The nutritional composition system of claim 1, wherein at least one of the nutritional compositions comprises lactoferrin.

12. The nutritional composition system of claim 1, wherein at least one of the nutritional compositions of the nutritional composition system is a synthetic nutritional composition.

13. The nutritional composition system of claim 1, for use in providing nutrition to an infant.

14-16. (canceled)

17. The nutritional composition system of claim 1, wherein the stage 1 nutritional composition comprises:
1.5 g/L to 4 g/L of 2FL;
0.1 g/L to 2 g/L of 3FL;
1 g/L to 4.2 g/L of LNT;
0.01 g/L to 0.2 g/L of 3SL; and, 0.01 g/L to 0.45 g/L of 6SL.

18. (canceled)

19. The nutritional composition system of claim 1, wherein the stage 2 nutritional composition comprises:
1.3 g/L to 2 g/L of 2FL;
0.5 g/L to 2.2 g/L of 3FL;
0.5 g/L to 1.7 g/L of LNT;
0.1 g/L to 0.35 g/L of 3SL; and,
0.01 g/L to 0.1 g/L of 6SL.

20-21. (canceled)

22. A staged feeding regimen, comprising the steps of:
a) administering a stage 1 nutritional composition to an infant between 0 and 6 months of age;
b) administering a stage 2 nutritional composition to an infant between 6 and 12 months of age,
wherein the stage 1 and stage 2 nutritional compositions comprise human milk oligosaccharides,
wherein the human milk oligosaccharides comprise 2FL, 3FL, LNT, 3SL, and 6SL,
wherein the stage 1 and stage 2 nutritional compositions comprise different amounts of one or more of the human milk oligosaccharides.

23. The staged feeding regimen of claim 22, wherein the stage 1 and stage 2 nutritional compositions comprise:
Stage 1 (g/L) Stage 2 (g/L)
2FL 1.5-4 1.3-2
3FL 0.1-2 0.5-2.2
LNT 1-4.2 0.5-1.7
3SL 0.01-0.2 0.1-0.35
6SL 0.01-0.45 0.01-0.1

24-25. (canceled)

26. An infant nutrition kit comprising a set of nutritional compositions according to claim 1.
